(19) United States
(12) Patent Application Publication
(10) Pub. No.: US 2026/0046952 A1
(43) Pub. Date: Feb. 12, 2026

(54) OPERATION METHOD OF REMOTE UE HAVING IDEAL LINK CONNECTION IN WIRELESS COMMUNICATION SYSTEM

(71) Applicant: LG ELECTRONICS INC., Seoul (KR)

(72) Inventors: Seoyoung BACK, Seoul (KR); Seungmin LEE, Seoul (KR); Youngdae LEE, Seoul (KR); Giwon PARK, Seoul (KR); Laeyoung KIM, Seoul (KR); Seokjung KIM, Seoul (KR)

(73) Assignee: LG ELECTRONICS INC., Seoul (KR)

(21) Appl. No.: 18/998,984

(22) PCT Filed: Jul. 27, 2023
(86) PCT No.: PCT/KR2023/010952

§ 371 Date: Jan. 27, 2025

Related U.S. Application Data
(60) Provisional application No. 63/398,549, filed on Aug. 17, 2022.

(30) Foreign Application Priority Data
Jul. 28, 2022 (KR) 10-2022-0094222
Aug. 2, 2022 (KR) 10-2022-0096386

(51) Int. Cl. H04W 76/14; H04W 76/20; H04W 92/18

(52) U.S. Cl. CPC H04W 76/14; H04W 76/20; H04W 92/18

(57) ABSTRACT

An embodiment relates to an operation method of a remote user equipment (UE) related to a multi-path relay in a wireless communication system, the method comprising: establishing a radio resource control (RRC) connection to a base station by the remote UE; identifying possession of an ideal link connection to a relay UE by the remote UE; and reporting, to the base station, the possession of the ideal link connection by the remote UE, wherein the remote UE ignores, on the basis of the possession of the ideal link connection, a configuration related to a multi-path relay operation, which is received from the base station.

### CROSS-REFERENCE TO RELATED APPLICATION(S)

This application is the National Stage filing under 35 U.S.C. 371 of International Application No. PCT/KR2023/010952, filed on Jul. 27, 2023, which claims the benefit of earlier filing date and right of priority to Korean Application Nos. 10-2022-0094222, filed on Jul. 28, 2022, and 10-2022-0096386, filed on Aug. 2, 2022, and also claims the benefit of U.S. Provisional Application No. 63/398,549, filed on Aug. 17, 2022, the contents of which are all hereby incorporated by reference herein in their entireties.

### TECHNICAL FIELD

The following description relates to a wireless communication system, and more specifically, to a method and apparatus for operating a UE regarding issues related to operations of a remote UE and a relay UE having an ideal link connection between them, and a BS.

### BACKGROUND

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now; multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

FIG. 1 is a diagram illustrating V2X communication based on pre-NR RAT and V2X communication based on NR in comparison.

For V2X communication, a technique of providing safety service based on V2X messages such as basic safety message (BSM), cooperative awareness message (CAM), and decentralized environmental notification message (DENM) was mainly discussed in the pre-NR RAT. The V2X message may include location information, dynamic information, and attribute information. For example, a UE may transmit a CAM of a periodic message type and/or a DENM of an event-triggered type to another UE.

For example, the CAM may include basic vehicle information including dynamic state information such as a direction and a speed, vehicle static data such as dimensions, an external lighting state, path details, and so on. For example, the UE may broadcast the CAM which may have a latency less than 100 ms. For example, when an unexpected incident occurs, such as breakage or an accident of a vehicle, the UE may generate the DENM and transmit the DENM to another UE. For example, all vehicles within the transmission range of the UE may receive the CAM and/or the DENM. In this case, the DENM may have priority over the CAM.

In relation to V2X communication, various V2X scenarios are presented in NR. For example, the V2X scenarios include vehicle platooning, advanced driving, extended sensors, and remote driving.

For example, vehicles may be dynamically grouped and travel together based on vehicle platooning. For example, to perform platoon operations based on vehicle platooning, the vehicles of the group may receive periodic data from a leading vehicle. For example, the vehicles of the group may widen or narrow their gaps based on the periodic data.

For example, a vehicle may be semi-automated or full-automated based on advanced driving. For example, each vehicle may adjust a trajectory or maneuvering based on data obtained from a nearby vehicle and/or a nearby logical entity. For example, each vehicle may also share a dividing intention with nearby vehicles.

Based on extended sensors, for example, raw or processed data obtained through local sensor or live video data may be exchanged between vehicles, logical entities, in terminals of pedestrians and/or V2X application servers. Accordingly, a vehicle may perceive an advanced environment relative to an environment perceivable by its sensor.

Based on remote driving, for example, a remote driver or a V2X application may operate or control a remote vehicle on behalf of a person incapable of driving or in a dangerous environment. For example, when a path may be predicted as in public transportation, cloud computing-based driving may be used in operating or controlling the remote vehicle. For example, access to a cloud-based back-end service platform may also be used for remote driving.

A scheme of specifying service requirements for various V2X scenarios including vehicle platooning, advanced driving, extended sensors, and remote driving is under discussion in NR-based V2X communication.

### SUMMARY

The present disclosure addresses technical issues related to operations of a remote UE and a relay UE having an ideal link connection between them, and a BS.

According to an embodiment, a method of operating a remote user equipment (UE) related to multi-path relay in a wireless communication system includes establishing a radio resource control (RRC) connection with a base station (BS) by the remote UE, identifying that the remote UE has an ideal link connection to a relay UE by the remote UE, and reporting to the BS that the remote UE has the ideal link connection by the remote UE. Based on having the ideal link connection, the remote UE ignores a configuration related to a multi-path relay operation, received from the BS.

According to an embodiment, a remote UE in a wireless communication system includes at least one processor, and at least one computer memory operatively connected to the at least one processor, and storing instructions that, when executed, cause the at least one processor to perform operations. The operations include establishing an RRC connection with a BS by the remote UE, identifying that the remote UE has an ideal link connection to a relay UE by the remote UE, and reporting to the BS that the remote UE has the ideal link connection by the remote UE. Based on having the ideal link connection, the remote UE ignores a configuration related to a multi-path relay operation, received from the BS.

The ideal link connection may correspond to a non-3GPP radio access technology (RAT).

The non-3GPP RAT may include Bluetooth and Wi-Fi.

The configuration related to the multi-path relay operation may include at least one of 1) a QoS split configuration, 2) an SL bearer configuration related to relay, 3) an SL pool configuration, 4) related grant information in case of operation in Model, 5) a measurement report for a candidate relay UE, or 6) a bearer mapping-related configuration.

Even if the remote UE has the ideal link connection, the BS may configure at least one of a Uu data bearer required to forward data of the remote UE to the relay UE, a local ID to be used for transmitting data of the remote UE between the relay UE and the BS, information related to a HO command, or information related to a HO failure.

The HO command and the HO failure may be related to HO of the remote UE and the relay UE to the same BS.

The report may include a source ID (SRC ID) and a destination ID (DST ID) assigned by a higher layer.

The report may include a link ID for an ideal link.

The report may be performed through SidelinkUEInformation (SUI).

The report may be performed through a higher layer of the remote UE.

The remote UE may communicate with at least one of another UE, a UE related to an autonomous driving vehicle, a BS, or a network.

According to an embodiment, a remote UE and a relay UE may avoid allocation of an unnecessary configuration by indicating to a gNB that the remote UE and the relay UE are connected via an ideal link. Further, even if an unnecessary configuration is received, an operation of not applying it may be applied exceptionally.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram for explaining comparison between vehicle-to-everything (V2X) communication based on pre-new radio (NR) radio access technology (RAT) and V2X communication based on NR;

FIG. 2 illustrates the structure of a Long Term Evolution (LTE) system according to an embodiment of the present disclosure;

FIG. 3 illustrates radio protocol architectures for user and control planes according to an embodiment of the present disclosure;

FIG. 4 illustrates the structure of a new radio (NR) system according to an embodiment of the present disclosure;

FIG. 5 illustrates a functional division between a next generation radio access network (NG-RAN) and a fifth-generation core (5GC) according to an embodiment of the present disclosure;

FIG. 6 illustrates the structure of a radio frame of NR to which embodiment(s) are applicable;

FIG. 7 illustrates the structure of a slot in an NR frame according to an embodiment of the present disclosure;

FIG. 8 illustrates a radio protocol architecture for sidelink (SL) communication according to an embodiment of the present disclosure;

FIG. 9 illustrates a radio protocol architecture for SL communication according to an embodiment of the present disclosure;

FIG. 10 illustrates a synchronization source or synchronization reference of V2X according to an embodiment of the present disclosure;

FIG. 11 illustrates a procedure for a user equipment (UE) to perform V2X or SL communication depending on transmission modes according to an embodiment of the present disclosure;

FIG. 12 illustrates a procedure for performing path switching by a UE according to an embodiment of the present disclosure;

FIG. 13 illustrates direct to indirect path switching;

FIGS. 14 and 15 illustrate UE-to-UE relay selection;

FIGS. 16 to 19 illustrate an embodiment; and

FIGS. 20 to 26 are diagrams illustrating various devices to which embodiment(s) are applicable

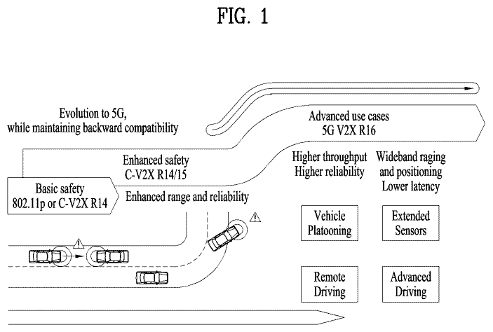

### DETAILED DESCRIPTION

In various embodiments of the present disclosure, “/” and “,” should be interpreted as “and/or”. For example, “A/B” may mean “A and/or B”. Further, “A, B” may mean “A and/or B”. Further, “A/B/C” may mean “at least one of A, B and/or C”. Further, “A, B, C” may mean “at least one of A, B and/or C”.

In various embodiments of the present disclosure, “or” should be interpreted as “and/or”. For example, “A or B” may include “only A”, “only B”, and/or “both A and B”. In other words, “or” should be interpreted as “additionally or alternatively”.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHZ, an intermediate frequency band between 1 GHZ and 10 GHZ, and a high frequency (millimeter) band of 24 GHz or above.

While the following description is given mainly in the context of LTE-A or 5G NR for the clarity of description, the technical idea of an embodiment of the present disclosure is not limited thereto.

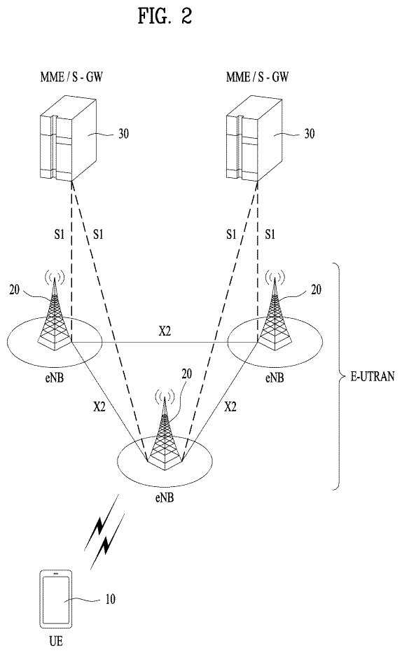

FIG. 2 illustrates the structure of an LTE system according to an embodiment of the present disclosure. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

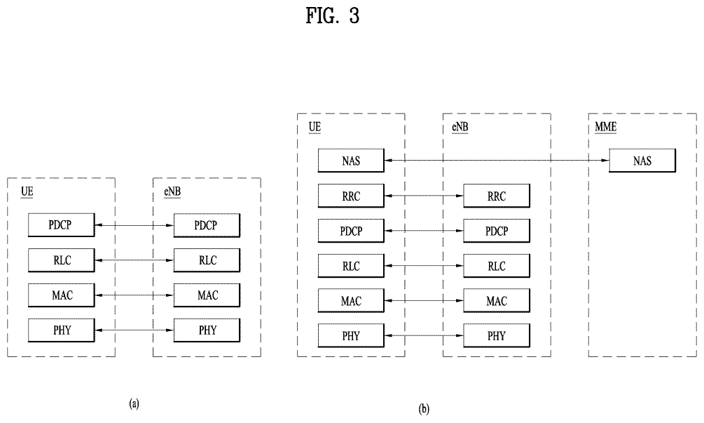

FIG. 3(a) illustrates a user-plane radio protocol architecture according to an embodiment of the disclosure.

FIG. 3(b) illustrates a control-plane radio protocol architecture according to an embodiment of the disclosure. A user plane is a protocol stack for user data transmission, and a control plane is a protocol stack for control signal transmission.

Referring to FIGS. 3(a) and 3(b), the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel. A MAC sublayer provides a data transmission service on the logical channels.

The RLC layer performs concatenation, segmentation, and reassembly for RLC serving data units (SDUs). In order to guarantee various quality of service (QoS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbol in the time domain by a plurality of subcarriers in the frequency domain. One subframe includes a plurality of OFDM symbols in the time domain. An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

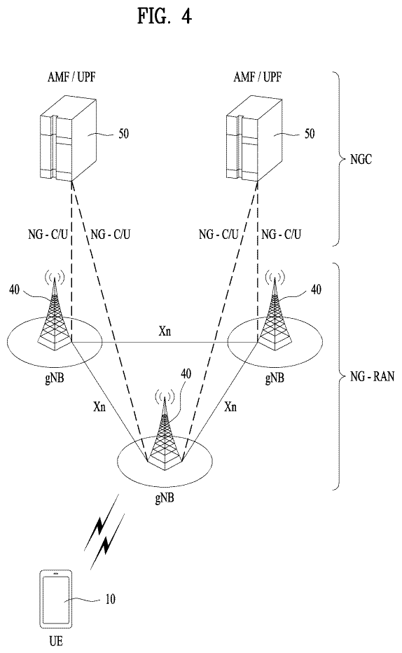

FIG. 4 illustrates the structure of an NR system according to an embodiment of the present disclosure.

Referring to FIG. 4, a next generation radio access network (NG-RAN) may include a next generation Node B (gNB) and/or an eNB, which provides user-plane and control-plane protocol termination to a UE. In FIG. 4, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

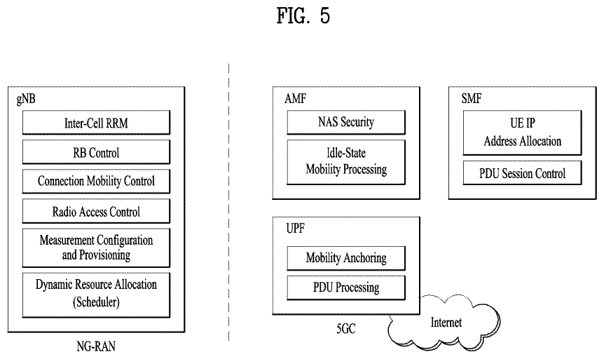

FIG. 5 illustrates functional split between the NG-RAN and the 5GC according to an embodiment of the present disclosure.

Referring to FIG. 5, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

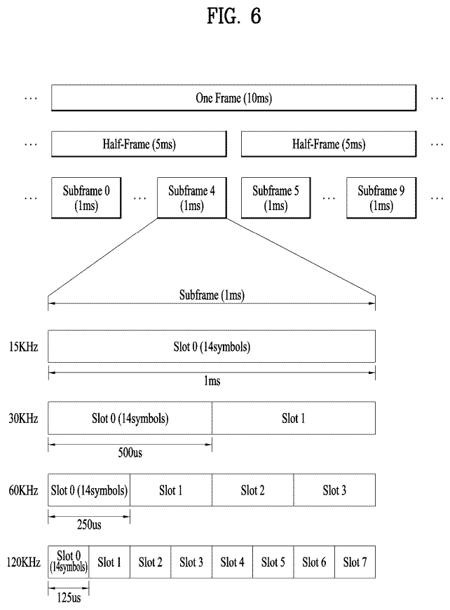

FIG. 6 illustrates a radio frame structure in NR, to which embodiment(s) of the present disclosure is applicable.

Referring to FIG. 6, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,μ}ₛₗₒₜ, and the number of slots per subframe N^{subframe,μ}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM(A) numerologies (e.g., SCSs, CP lengths, and so on) may be configured for a plurality of cells aggregated for one UE. Accordingly, the (absolute time) duration of a time resource including the same number of symbols (e.g., a subframe, slot, or TTI) (collectively referred to as a time unit (TU) for convenience) may be configured to be different for the aggregated cells.

In NR, various numerologies or SCSs may be supported to support various 5G services. For example, with an SCS of 15 kHz, a wide area in traditional cellular bands may be supported, while with an SCS of 30/60 KHz, a dense urban area, a lower latency, and a wide carrier bandwidth may be supported. With an SCS of 60 KHz or higher, a bandwidth larger than 24.25 GHz may be supported to overcome phase noise.

An NR frequency band may be defined by two types of frequency ranges, FR1 and FR2. The numerals in each frequency range may be changed. For example, the two types of frequency ranges may be given in [Table 3]. In the NR system, FR1 may be a “sub 6 GHZ range” and FR2 may be an “above 6 GHz range” called millimeter wave (mmW).

TABLE 3

| Frequency Range | Corresponding | Subcarrier Spacing |
|---|---|---|
| designation | frequency range | (SCS) |
| FR1 | 450 MHz-6000 MHz | 15, 30, 60 kHz |
| FR2 | 24250 MHz-52600 MHz | 60, 120, 240 kHz |

As mentioned above, the numerals in a frequency range may be changed in the NR system. For example, FR1 may range from 410 MHz to 7125 MHz as listed in [Table 4]. That is, FR1 may include a frequency band of 6 GHZ (or 5850, 5900, and 5925 MHz) or above. For example, the frequency band of 6 GHZ (or 5850, 5900, and 5925 MHz) or above may include an unlicensed band. The unlicensed band may be used for various purposes, for example, vehicle communication (e.g., autonomous driving).

TABLE 4

| Frequency Range | Corresponding | Subcarrier Spacing |
|---|---|---|
| designation | frequency range | (SCS) |
| FR1 | 410 MHz-7125 MHz | 15, 30, 60 kHz |
| FR2 | 24250 MHz-52600 MHz | 60, 120, 240 kHz |

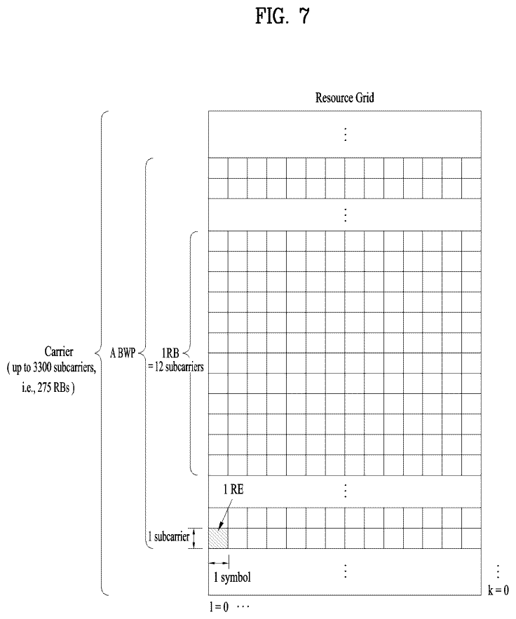

FIG. 7 illustrates a slot structure in an NR frame according to an embodiment of the present disclosure.

Referring to FIG. 7, a slot includes a plurality of symbols in the time domain. For example, one slot may include 14 symbols in an NCP case and 12 symbols in an ECP case. Alternatively, one slot may include 7 symbols in an NCP case and 6 symbols in an ECP case.

A carrier includes a plurality of subcarriers in the frequency domain. An RB may be defined by a plurality of (e.g., 12) consecutive subcarriers in the frequency domain. A bandwidth part (BWP) may be defined by a plurality of consecutive (physical) RBs ((P) RBs) in the frequency domain and correspond to one numerology (e.g., SCS, CP length, or the like). A carrier may include up to N (e.g., 5) BWPs. Data communication may be conducted in an activated BWP. Each element may be referred to as a resource element (RE) in a resource grid, to which one complex symbol may be mapped.

A radio interface between UEs or a radio interface between a UE and a network may include L1, L2, and L3. In various embodiments of the present disclosure, L1 may refer to the PHY layer. For example, L2 may refer to at least one of the MAC layer, the RLC layer, the PDCH layer, or the SDAP layer. For example, L3 may refer to the RRC layer.

Now, a description will be given of sidelink (SL) communication.

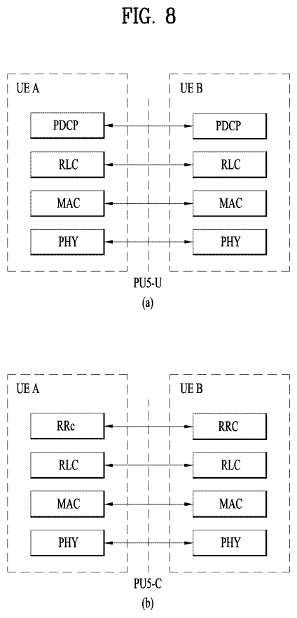

FIG. 8 illustrates a radio protocol architecture for SL communication according to an embodiment of the present disclosure. Specifically, FIG. 8(a) illustrates a user-plane protocol stack in LTE, and FIG. 8(b) illustrates a control-plane protocol stack in LTE.

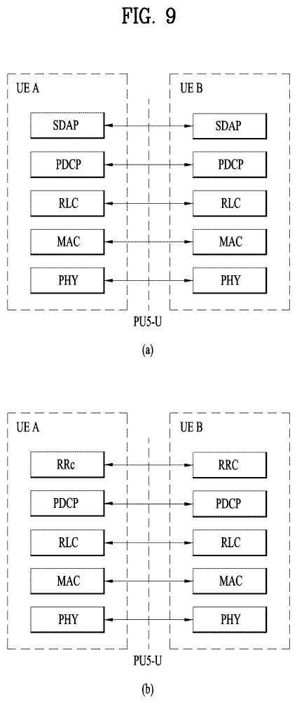

FIG. 9 illustrates a radio protocol architecture for SL communication according to an embodiment of the present disclosure. Specifically, FIG. 9(a) illustrates a user-plane protocol stack in NR, and FIG. 9(b) illustrates a control-plane protocol stack in NR.

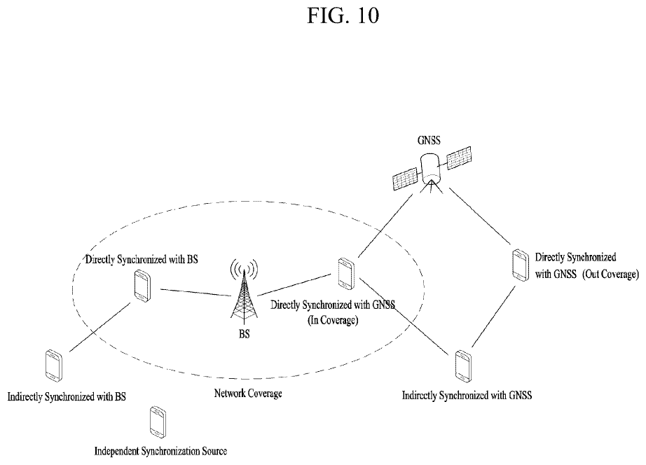

FIG. 10 illustrates a synchronization source or synchronization reference of V2X according to an embodiment of the present disclosure.

Referring to FIG. 10, in V2X, a UE may be directly synchronized with global navigation satellite systems (GNSS). Alternatively, the UE may be indirectly synchronized with the GNSS through another UE (within or out of network coverage). If the GNSS is configured as a synchronization source, the UE may calculate a direct frame number (DFN) and a subframe number based on a coordinated universal time (UTC) and a configured (or preconfigured) DFN offset.

Alternatively, a UE may be directly synchronized with a BS or may be synchronized with another UE that is synchronized in time/frequency with the BS. For example, the BS may be an eNB or a gNB. For example, when a UE is in network coverage, the UE may receive synchronization information provided by the BS and may be directly synchronized with the BS. Next, the UE may provide the synchronization information to another adjacent UE. If a timing of the BS is configured as a synchronization reference, the UE may follow a cell associated with a corresponding frequency (when the UE is in cell coverage in frequency) or a primary cell or a serving cell (when the UE is out of cell coverage in frequency), for synchronization and DL measurement.

The BS (e.g., serving cell) may provide a synchronization configuration for a carrier used for V2X/SL communication. In this case, the UE may conform to the synchronization configuration received from the BS. If the UE fails to detect any cell in the carrier used for V2X/SL communication and fails to receive the synchronization configuration from the serving cell, the UE may conform to a preset synchronization configuration.

Alternatively, the UE may be synchronized with another UE that has failed to directly or indirectly acquire the synchronization information from the BS or the GNSS. A synchronization source and a preference may be preconfigured for the UE. Alternatively, the synchronization source and the preference may be configured through a control message provided by the BS.

SL synchronization sources may be associated with synchronization priority levels. For example, a relationship between synchronization sources and synchronization priorities may be defined as shown in Table 5 or 6. Table 5 or 6 is merely an example, and the relationship between synchronization sources and synchronization priorities may be defined in various ways.

TABLE 5

| | | BS-based synchronization |
|---|---|---|
| Priority | | (eNB/gNB-based |
| level | GNSS-based synchronization | synchronization) |
| P0 | GNSS | BS |
| P1 | All UEs directly | All UEs directly |
| | synchronized with GNSS | synchronized with BS |
| P2 | All UEs indirectly | All UEs indirectly |
| | synchronized with GNSS | synchronized with BS |
| P3 | All other UEs | GNSS |
| P4 | N/A | All UEs directly |
| | | synchronized with GNSS |
| P5 | N/A | All UEs indirectly |
| | | synchronized with GNSS |
| P6 | N/A | All other UEs |

TABLE 6

| | | BS-based synchronization |
|---|---|---|
| Priority | | (eNB/gNB-based |
| level | GNSS-based synchronization | synchronization) |
| P0 | GNSS | BS |
| P1 | All UEs directly | All UEs directly |
| | synchronized with GNSS | synchronized with BS |
| P2 | All UEs indirectly | All UEs indirectly |
| | synchronized with GNSS | synchronized with GNSS |
| P3 | BS | GNSS |
| P4 | All UEs directly | All UEs directly |
| | synchronized with GNSS | synchronized with GNSS |
| P5 | All UEs indirectly | All UEs indirectly |
| | synchronized with GNSS | synchronized with GNSS |
| P6 | Remaining UE(s) with | Remaining UE(s) with |
| | low priority | low priority |

In Table 5 or 6, P0 may mean the highest priority, and P6 may mean the lowest priority. In Table 5 or 6, the BS may include at least one of a gNB or an eNB.

Whether to use GNSS-based synchronization or eNB/gNB-based synchronization may be (pre) configured. In a single-carrier operation, the UE may derive a transmission timing thereof from an available synchronization reference having the highest priority.

Hereinafter, a sidelink synchronization signal (SLSS) and synchronization information will be described.

As an SL-specific sequence, the SLSS may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may use the S-PSS to detect an initial signal and obtain synchronization. In addition, the UE may use the S-PSS and the S-SSS to obtain detailed synchronization and detect a synchronization signal ID.

A physical sidelink broadcast channel (PSBCH) may be a (broadcast) channel for transmitting default (system) information that the UE needs to know first before transmitting and receiving SL signals. For example, the default information may include information related to an SLSS, a duplex mode (DM), a time division duplex (TDD) UL/DL configuration, information related to a resource pool, an application type related to the SLSS, a subframe offset, broadcast information, etc. For example, for evaluation of PSBCH performance in NR V2X, the payload size of the PSBCH may be 56 bits including a CRC of 24 bits.

The S-PSS, S-SSS, and PSBCH may be included in a block format (e.g., SL synchronization signal (SS)/PSBCH block) supporting periodical transmission (hereinafter, the SL SS/PSBCH block is referred to as a sidelink synchronization signal block (S-SSB)). The S-SSB may have the same numerology (i.e., SCS and CP length) as that of a physical sidelink control channel (PSCCH)/physical sidelink shared channel (PSSCH) on a carrier, and the transmission bandwidth may exist within a configured (or preconfigured) SL BWP. For example, the S-SSB may have a bandwidth of 11 RBs. For example, the PSBCH may span 11 RBs. In addition, the frequency position of the S-SSB may be configured (or preconfigured). Therefore, the UE does not need to perform hypothesis detection on frequency to discover the S-SSB on the carrier.

The NR SL system may support a plurality of numerologies with different SCSs and/or different CP lengths. In this case, as the SCS increases, the length of a time resource used by a transmitting UE to transmit the S-SSB may decrease. Accordingly, the coverage of the S-SSB may be reduced. Therefore, in order to guarantee the coverage of the S-SSB, the transmitting UE may transmit one or more S-SSBs to a receiving UE within one S-SSB transmission period based on the SCS. For example, the number of S-SSBs that the transmitting UE transmits to the receiving UE within one S-SSB transmission period may be pre-configured or configured for the transmitting UE. For example, the S-SSB transmission period may be 160 ms. For example, an S-SSB transmission period of 160 ms may be supported for all SCSs.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 KHz, in FR1, the transmitting UE may transmit one, two, or four S-SSBs to the receiving UE within one S-SSB transmission period.

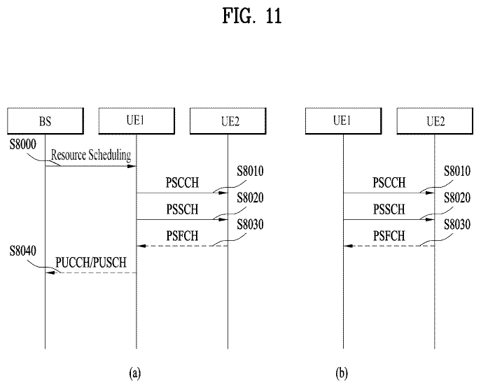

FIG. 11 illustrates a procedure of performing V2X or SL communication by a UE depending on a transmission mode according to an embodiment of the present disclosure. The embodiment of FIG. 11 may be combined with various embodiments of the present disclosure. In various embodiments of the present disclosure, a transmission mode may be referred to as a mode or a resource allocation mode. For the convenience of the following description, a transmission mode in LTE may be referred to as an LTE transmission mode, and a transmission mode in NR may be referred to as an NR resource allocation mode.

For example, FIG. 11(a) illustrates a UE operation related to LTE transmission mode 1 or LTE transmission mode 3. Alternatively, for example, FIG. 11(a) illustrates a UE operation related to NR resource allocation mode 1. For example, LTE transmission mode 1 may apply to general SL communication, and LTE transmission mode 3 may apply to V2X communication.

For example, FIG. 11(b) illustrates a UE operation related to LTE transmission mode 2 or LTE transmission mode 4. Alternatively, for example, FIG. 11(b) illustrates a UE operation related to NR resource allocation mode 2.

Referring to FIG. 11(a), in LTE transmission mode 1, LTE transmission mode 3, or NR resource allocation mode 1, a BS may schedule an SL resource to be used for SL transmission by a UE. For example, in step S8000, the BS may transmit information related to an SL resource and/or information related to a UE resource to a first UE. For example, the UL resource may include a PUCCH resource and/or a PUSCH resource. For example, the UL resource may be a resource to report SL HARQ feedback to the BS.

For example, the first UE may receive information related to a Dynamic Grant (DG) resource and/or information related to a Configured Grant (CG) resource from the BS. For example, the CG resource may include a CG type 1 resource or a CG type 2 resource. In the present specification, the DG resource may be a resource configured/allocated by the BS to the first UE in Downlink Control Information (DCI). In the present specification, the CG resource may be a (periodic) resource configured/allocated by the BS to the first UE in DCI and/or an RRC message. For example, for the CG type 1 resource, the BS may transmit an RRC message including information related to the CG resource to the first UE. For example, for the CG type 2 resource, the BS may transmit an RRC message including information related to the CG resource to the first UE, and the BS may transmit DCI for activation or release of the CG resource to the first UE.

In step S8010, the first UE may transmit a PSCCH (e.g., Sidelink Control Information (SCI) or 1st-stage SCI) to a second UE based on the resource scheduling. In step S8020, the first UE may transmit a PSSCH (e.g., 2nd-stage SCI, MAC PDU, data, etc.) related to the PSCCH to the second UE. In step S8030, the first UE may receive a PSFCH related to the PSCCH/PSSCH from the second UE. For example, HARQ feedback information (e.g., NACK information or ACK information) may be received from the second UE over the PSFCH. In step S8040, the first UE may transmit/report HARQ feedback information to the BS over a PUCCH or PUSCH. For example, the HARQ feedback information reported to the BS may include information generated by the first UE based on HARQ feedback information received from the second UE. For example, the HARQ feedback information reported to the BS may include information generated by the first UE based on a preset rule. For example, the DCI may be a DCI for scheduling of SL. For example, the format of the DCI may include DCI format 3_0 or DCI format 3_1. Table 7 shows one example of DCI for scheduling of SL.

TABLE 7
7.3.1.4.1 Format 3_0
DCI format 3_0 is used for scheduling of NR PSCCH and NR PSSCH in one cell.
The following information is transmitted by means of the DCI format 3_0 with CRC
scrambled by SL-RNTI or SL-CS-RNTI:
- Resource pool index - [log₂ I] bits, where I is the number of resource pools for
transmission configured by the higher layer parameter sl-TxPoolScheduling.
- Time gap - 3 bits determined by higher layer parameter sl-DCI-ToSL-Trans, as
defined in clause 8.1.2.1 of [6, TS 38.214]
- HARQ process number - 4 bits.
- New data indicator - 1 bit.
- Lowest index of the subchannel allocation to the initial transmission
$⌈ {log}_{2} ( {N}_{subChannel}^{SL} ) ⌉ bits as defined in clause 8.1 \text{.2} \text{.2} of [ 6 , TS 38.214 ]$
- SCI format 1-A fields according to clause 8.3.1.1:
- Frequency resource assignment.
- Time resource assignment.
- PSFCH-to-HARQ feedback timing indicator - ┌log₂N_{fb}_timing┐ bits, where N_{fb}_timing
is the number of entries in the higher layer parameter sl-PSFCH-ToPUCCH, as defined in
clause 16.5 of [5, TS 38.213]
- PUCCH resource indicator - 3 bits as defined in clause 16.5 of [5, TS 38.213].
- Configuration index - 0 bit if the UE is not configured to monitor DCI format 3_0
with CRC scrambled by SL-CS-RNTI; otherwise 3 bits as defined in clause 8.1.2 of [6, TS
38.214]. If the UE is configured to monitor DCI format 3_0 with CRC scrambled by SL-CS-
RNTI, this field is reserved for DCI format 3_0 with CRC scrambled by SL-RNTI.
- Counter sidelink assignment index - 2 bits
- 2 bits as defined in clause 16.5.2 of [5, TS 38.213] if the UE is configured with pdsch-
HARQ-ACK-Codebook = dynamic
- 2 bits as defined in clause 16.5.1 of [5, TS 38.213] if the UE is configured with pdsch-
HARQ-ACK-Codebook = semi-static
- Padding bits, if required
If multiple transmit resource pools are provided in sl-TxPoolScheduling, zeros shall be
appended to the DCI format 3_0 until the payload size is equal to the size of a DCI format
3_0 given by a configuration of the transmit resource pool resulting in the largest number of
information bits for DCI format 3_0.
If the UE is configured to monitor DCI format 3_1 and the number of information bits in DCI
format 3_0 is less than the payload of DCI format 3_1, zeros shall be appended to DCI format
3_0 until the payload size equals that of DCI format 3_1.
7.3.1.4.2 Format 3_1
DCI format 3_1 is used for scheduling of LTE PSCCH and LTE PSSCH in one cell.
The following information is transmitted by means of the DCI format 3_1 with CRC
scrambled by SL Semi-Persistent Scheduling V-RNTI:
- Timing offset - 3 bits determined by higher layer parameter sl-TimeOffsetEUTRA-
List, as defined in clause 16.6 of [5, TS 38.213]
- Carrier indicator -3 bits as defined in 5.3.3.1.9A of [11, TS 36.212].
- Lowest index of the subchannel allocation to the initial transmission -
$⌈ {log}_{2} ( {N}_{subchannel}^{SL} ) ⌉ bits as defined in 5.3 \text{.3} \text{.1} \text{.9} A of [ 11 , TS 36.212 ] .$
- Frequency resource location of initial transmission and retransmission, as defined in
5.3.3.1.9A of [11, TS 36.212]
- Time gap between initial transmission and retransmission, as defined in 5.3.3.1.9A of
[11, TS 36.212]
- SL index - 2 bits as defined in 5.3.3.1.9A of [[11, TS 36.212]
- SL SPS configuration index - 3 bits as defined in clause 5.3.3.1.9A of [11, TS
36.212].
- Activation/release indication - 1 bit as defined in clause 5.3.3.1.9A of [11, TS
36.212].

Referring to FIG. 11(b), in an LTE transmission mode 2, an LTE transmission mode 4, or an NR resource allocation mode 2, a UE may determine an SL transmission resource within an SL resource configured by a BS/network or a preconfigured SL resource. For example, the configured SL resource or the preconfigured SL resource may be a resource pool. For example, the UE may autonomously select or schedule resources for SL transmission. For example, the UE may perform SL communication by selecting a resource by itself within a configured resource pool. For example, the UE may perform sensing and resource (re) selection procedures to select a resource by itself within a selection window. For example, the sensing may be performed in unit of a sub-channel. For example, in the step S8010, the first UE having self-selected a resource in the resource pool may transmit PSCCH (e.g., Side Link Control Information (SCI) or 1st-stage SCI) to the second UE using the resource. In the step S8020, the first UE may transmit PSSCH (e.g., 2nd-stage SCI, MAC PDU, data, etc.) related to the PSCCH to the second UE. In the step S8030, the first UE may receive PSFCH related to the PSCCH/PSSCH from the second UE.

Referring to FIG. 11(a) or FIG. 11(b), for example, the first UE may transmit the SCI to the second UE on the PSCCH. Alternatively, for example, the first UE may transmit two consecutive SCIs (e.g., two-stage SCI) to the second UE on the PSCCH and/or PSSCH. In this case, the second UE may decode the two consecutive SCIs (e.g., two-stage SCI) to receive the PSSCH from the first UE. In the present specification, the SCI transmitted on the PSCCH may be referred to as a 1^{st} SCI, a 1^{st}-stage SCI, or a 1^{st}-stage SCI format, and the SCI transmitted on the PSSCH may be referred to as a 2nd SCI, a 2nd SCI, a 2nd-stage SCI format. For example, the 1st-stage SCI format may include SCI format 1-A, and the 2^{nd}-stage SCI format may include SCI format 2-A and/or SCI format 2-B. Table 8 shows one example of a 1^{st}-stage SCI format.

TABLE 8
8.3.1.1 SCI format 1-A
SCI format 1-A is used for the scheduling of PSSCH and 2^{nd}-stage-SCI on PSSCH
The following information is transmitted by means of the SCI format 1-A:
- Priority - 3 bits as specified in clause 5.4.3.3 of [12, TS 23.287] and clause 5.22.1.3.1
of [8, TS 38.321]. Value ‘000’ of Priority field corresponds to priority value ‘l’, value ‘001’ of
Priority field corresponds to priority value ‘2’, and so on.
$‐ Frequency resource assignment - ⌈ {log}_{2} ( \frac{{N}_{subChannel}^{SL} ( {N}_{subChannel}^{SL} + 1 )}{2} ) ⌉ bits when the value$
of the higher layer parameter sl-MaxNumPerReserve is configured to 2; otherwise
$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits when the value of the higher layer parameter$
sl-MaxNumPerReserve is configured to 3, as defined in clause 8.1.5 of [6, TS 38.214].
- Time resource assignment - 5 bits when the value of the higher layer parameter sl-
MaxNumPerReserve is configured to 2; otherwise 9 bits when the value of the higher layer
parameter sl-MaxNumPerReserve is configured to 3, as defined in clause 8.1.5 of [6, TS
38.214].
- Resource reservation period - ┌log₂Nᵣₛᵥ_period┐ bits as defined in clause 16.4 of [5, TS
38.213], where Nᵣₛᵥ_period is the number of entries in the higher layer parameter sl-
ResourceReservePeriodList, if higher layer parameter sl-MultiReserveResource is configured;
0 bit otherwise.
- DMRS pattern - ┌log₂Nₚₐₜₜₑᵣₙ┐ bits as defined in clause 8.4.1.1.2 of [4, TS 38.211],
where Nₚₐₜₜₑᵣₙ is the number of DMRS patterns configured by higher layer parameter sl-
is the number of DMRS patterns configured by higher layer parameter sl-
PSSCH-DMRS-TimePatternList.
- 2^{nd}-stage SCI format - 2 bits as defined in Table 8.3.1.1-1.
- Beta_offset indicator - 2 bits as provided by higher layer parameter sl-
BetaOffsets 2ndSCI and Table 8.3.1.1-2.
- Number of DMRS port - 1 bit as defined in Table 8.3.1.1-3.
- Modulation and coding scheme - 5 bits as defined in clause 8.1.3 of [6, TS 38.214].
- Additional MCS table indicator - as defined in clause 8.1.3.1 of [6, TS 38.214]: 1 bit
if one MCS table is configured by higher layer parameter sl-Additional-MCS-Table; 2 bits if
two MCS tables are configured by higher layer parameter sl-Additional-MCS-Table; 0 bit
otherwise.
- PSFCH overhead indication - 1 bit as defined clause 8.1.3.2 of [6, TS 38.214] if
higher layer parameter sl-PSFCH-Period = 2 or 4; 0 bit otherwise.
- Reserved - a number of bits as determined by higher layer parameter sl-
NumReservedBits, with value set to zero.

Table 9) shows exemplary 2nd-stage SCI formats.

TABLE 9

| | |
|---|---|
| 8.4 | Sidelink control information on PSSCH |

SCI carried on PSSCH is a 2nd-stage SCI, which transports sidelink scheduling information.

| | |
|---|---|
| 8.4.1 | 2nd-stage SCI formats |

The fields defined in each of the 2^{nd}-stage SCI formats below are mapped to the information
bits a₀ to a_{A-1} as follows:
Each field is mapped in the order in which it appears in the description, with the first field
mapped to the lowest order information bit a₀ and each successive field mapped to higher
order information bits. The most significant bit of each field is mapped to the lowest order
information bit for that field, e.g. the most significant bit of the first field is mapped to a₀.
8.4.1.1 SCI format 2-A
SCI format 2-A is used for the decoding of PSSCH, with HARQ operation when HARQ-
ACK information includes ACK or NACK, when HARQ-ACK information includes only
NACK, or when there is no feedback of HARQ-ACK information.
The following information is transmitted by means of the SCI format 2-A:

| | |
|---|---|
| - | HARQ process number - 4 bits. |
| - | New data indicator - 1 bit. |
| - | Redundancy version - 2 bits as defined in Table 7.3.1.1.1-2. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS |
| 38.213]. | |
| - | Cast type indicator - 2 bits as defined in Table 8.4.1.1-1 and in clause 8.1 of [6, TS |
| 38.214]. | |
| - | CSI request - 1 bit as defined in clause 8.2.1 of [6, TS 38.214] and in clause 8.1 of [6, |
| TS 38.214]. | |

Referring to FIG. 11(a) or FIG. 11(b), in step S8030, a first UE may receive a PSFCH based on Table 10. For example, the first UE and a second UE may determine a PSFCH resource based on Table 10, and the second UE may transmit HARQ feedback to the first UE on the PSFCH resource.

TABLE 10
16.3 UE procedure for reporting HARQ-ACK on sidelink
A UE may be indicated by an SCI format scheduling a PSSCH reception to transmit a PSFCH
with HARQ-ACK information in response to the PSSCH reception. The UE provides HARQ-
ACK information that includes ACK or NACK, or only NACK.
A UE may be provided, by sl-PSFCH-Period, a number of slots in a resource pool for a
period of PSFCH transmission occasion resources. If the number is zero, PSFCH
transmissions from the UE in the resource pool are disabled.
$A UE expects that slot {t}_{k}^{′ SL} ( 0 \leq k < {T}_{max}^{′} ) has a PSFCH transmission occasion resource$
$if k mod {N}_{PSSCH}^{PSFCH} = 0 , where {t}_{k}^{′ SL} is defined in [ 6 TS 38.214 ] , and {T}_{max}^{′} is a number of slots$
$that belong to the resource pool within 10240 msec according to [ 6 , TS 38214 ] , and {N}_{PSSCH}^{PSFCH}$
is provided by sl-PSFCH-Period.
A UE may be indicated by higher layers to not transmit a PSFCH in response to a PSSCH
reception [11, TS 38.321].
If a UE receives a PSSCH in a resource pool and the HARQ feedback enabled/disabled
indicator field in an associated SCI format 2-A or a SCI format 2-B has value 1 [5, TS
38.212], the UE provides the HARQ-ACK information in a PSFCH transmission in the
resource pool. The UE transmits the PSFCH in a first slot that includes PSFCH resources and
is at least a number of slots, provided by sl-MinTimeGapPSFCH, of the resource pool after a
last slot of the PSSCH reception.
$A UE is provided by sl ‐ PSFCH ‐ RB ‐ Set a set of {M}_{PRB , set}^{PSFCH} PRBs in a resource pool for PSFCH$
transmission in a PRB of the resource pool. For a number of N_{subch} sub-channels for the
resource pool, provided by sl-NumSubchannel, and a number of PSSCH slots associated with
$a PSFCH slot that is less than or equal to {N}_{PSSCH}^{PSFCH} , the UE allocates the$
$[ ( i + j \cdot {N}_{PSSCH}^{PSFCH} ) \cdot {M}_{subch , slot}^{PSFCH} , ( i + 1 + j \cdot {N}_{PSSCH}^{PSFCH} ) \cdot {M}_{subch , slot}^{PSFCH} - 1 ]$
$PRBs from the {M}_{PRB , set}^{PSFCH} PRBs to slot i$
among the PSSCH slots associated with the PSFCH slot and sub-channel j, where
${M}_{subch , slot}^{PSFCH} = {M}_{PRB , set}^{PSFCH} / ( {N}_{subch} \cdot {N}_{PSSCH}^{PSFCH} ) , 0 \leq i < {N}_{PSSCH}^{PSFCH} , 0 \leq j < {N}_{subch} , and the allocation$
starts in an ascending order of i and continues in an ascending order of j. The UE expects that
${M}_{PRB , set}^{PSFCH} is a multiple of {N}_{subch} \cdot {N}_{PSSCH}^{PSFCH} .$
The second OFDM symbol l′ of PSFCH transmission in a slot is defined as l′ =
sl-StartSymbol + sl-LengthSymbols − 2.
A UE determines a number of PSFCH resources available for multiplexing HARQ-ACK
$information in a PSFCH transmission as {R}_{PRB , CS}^{PSFCH} = {N}_{type}^{PSFCH} \cdot {M}_{subch , slot}^{PSFCH} \cdot {N}_{CS}^{PSFCH} where$
${N}_{CS}^{PSFCH} is a number of cyclic shift pairs for the resource pool provided by sl ‐ NumMuxCS ‐$
Pair and, based on an indication by sl-PSFCH-CandidateResourceType,
- $if sl ‐ PSFCH ‐ CandidateResourceType is configured as startSubCH , {N}_{type}^{PSFCH} = 1 and$
$the {M}_{subch , slot}^{PSFCH} PRBs are associated with the starting sub ‐ channel of the corresponding$
PSSCH;
- $if sl ‐ PSFCH ‐ CandidateResourceType is configured as allocSubCH , {N}_{type}^{PSFCH} = {N}_{subch}^{PSSCH}$
$and the {N}_{subch}^{PSSCH} \cdot {M}_{subch , slot}^{PSFCH} PRBs are associated with the$
${N}_{subch}^{PSSCH} sub ‐ channels of the corresponding PSSCH .$
The PSFCH resources are first indexed according to an ascending order of the PRB index,
$from the {N}_{type}^{PSFCH} \cdot {M}_{subch , slot}^{PSFCH} PRBs , and then according to an ascending order of the cyclic$
$shift pair index from the {N}_{CS}^{PSFCH} cyclic shift pairs .$
A UE determines an index of a PSFCH resource for a PSFCH transmission in response to a
$PSSCH reception as ( {P}_{ID} + {M}_{ID} ) mod {R}_{PRB , CS}^{PSFCH} where {P}_{ID} is a physical layer source ID$
provided by SCI format 2-A or 2-B [5, TS 38.212] scheduling the PSSCH reception, and M_{ID}
is the identity of the UE receiving the PSSCH as indicated by higher layers if the UE detects
a SCI format 2-A with Cast type indicator field value of “01”; otherwise, M_{ID} is zero.
A UE determines a mo value, for computing a value of cyclic shift α [4, TS 38.211], from a
cyclic shift pair index corresponding to a PSFCH resource index and from
${N}_{CS}^{PSFCH} using Table 16.3 - 1.$

Referring to FIG. 11(a), in step S8040, the first UE may transmit SL HARQ feedback to the BS over a PUCCH and/or PUSCH based on Table 11.

TABLE 11

| | |
|---|---|
| 16.5 | UE procedure for reporting HARQ-ACK on uplink |

A UE may be provided PUCCH resources or PUSCH resources [12, TS 38.331] to report
HARQ-ACK information that the UE generates based on HARQ-ACK information that the
UE obtains from PSFCH receptions, or from absence of PSFCH receptions. The UE reports
HARQ-ACK information on the primary cell of the PUCCH group, as described in clause 9,
of the cell where the UE monitors PDCCH for detection of DCI format 3_0.
For SL configured grant Type 1 or Type 2 PSSCH transmissions by a UE within a time period
provided by sl-PeriodCG, the UE generates one HARQ-ACK information bit in response to
the PSFCH receptions to multiplex in a PUCCH transmission occasion that is after a last time
resource, in a set of time resources.
For PSSCH transmissions scheduled by a DCI format 3_0, a UE generates HARQ-ACK
information in response to PSFCH receptions to multiplex in a PUCCH transmission
occasion that is after a last time resource in a set of time resources provided by the DCI
format 3_0.
From a number of PSFCH reception occasions, the UE generates HARQ-ACK information to
report in a PUCCH or PUSCH transmission. The UE may be indicated by a SCI format to
perform one of the following and the UE constructs a HARQ-ACK codeword with HARQ-
ACK information, when applicable

| | |
|---|---|
| - | for one or more PSFCH reception occasions associated with SCI format 2-A with Cast |

type indicator field value of “10”

| | |
|---|---|
| - | generate HARQ-ACK information with same value as a value of HARQ-ACK |

information the UE determines from the last PSFCH reception from the number of PSFCH
reception occasions corresponding to PSSCH transmissions or, if the UE determines that a
PSFCH is not received at the last PSFCH reception occasion and ACK is not received in any
of previous PSFCH reception occasions, generate NACK

| | |
|---|---|
| - | for one or more PSFCH reception occasions associated with SCI format 2-A with Cast |

type indicator field value of “01”

| | |
|---|---|
| - | generate ACK if the UE determines ACK from at least one PSFCH reception |

occasion, from the number of PSFCH reception occasions corresponding to PSSCH
transmissions, in PSFCH resources corresponding to every identity M_{ID} of the UEs that the
UE expects to receive the PSSCH, as described in clause 16.3; otherwise, generate NACK

| | |
|---|---|
| - | for one or more PSFCH reception occasions associated with SCI format 2-B or SCI |

format 2-A with Cast type indicator field value of “11”

| | |
|---|---|
| - | generate ACK when the UE determines absence of PSFCH reception for the last |

PSFCH reception occasion from the number of PSFCH reception occasions corresponding to
PSSCH transmissions; otherwise, generate NACK
After a UE transmits PSSCHs and receives PSFCHs in corresponding PSFCH resource
occasions, the priority value of HARQ-ACK information is same as the priority value of the
PSSCH transmissions that is associated with the PSFCH reception occasions providing the
HARQ-ACK information.
The UE generates a NACK when, due to prioritization, as described in clause 16.2.4, the UE
does not receive PSFCH in any PSFCH reception occasion associated with a PSSCH
transmission in a resource provided by a DCI format 3_0 or, for a configured grant, in a
resource provided in a single period and for which the UE is provided a PUCCH resource to
report HARQ-ACK information. The priority value of the NACK is same as the priority
value of the PSSCH transmission.
The UE generates a NACK when, due to prioritization as described in clause 16.2.4, the UE
does not transmit a PSSCH in any of the resources provided by a DCI format 3_0 or, for a
configured grant, in any of the resources provided in a single period and for which the UE is
provided a PUCCH resource to report HARQ-ACK information. The priority value of the
NACK is same as the priority value of the PSSCH that was not transmitted due to
prioritization.
The UE generates an ACK if the UE does not transmit a PSCCH with a SCI format 1-A
scheduling a PSSCH in any of the resources provided by a configured grant in a single period
and for which the UE is provided a PUCCH resource to report HARQ-ACK information. The
priority value of the ACK is same as the largest priority value among the possible priority
values for the configured grant.

Table 12 below shows details of selection and reselection of an SL relay UE defined in 3GPP TS 36.331. The contents of Table 12 are used as the prior art of the present disclosure, and related necessary details may be found in 3GPP TS 36.331.

TABLE 12

| | |
|---|---|
| 5.10.11.4 | Selection and reselection of sidelink relay UE |

A UE capable of sidelink remote UE operation that is configured by upper layers to search for
a sidelink relay UE shall:
if out of coverage on the frequency used for sidelink communication, as defined in TS 36.304
[4], clause 11.4; or
if the serving frequency is used for sidelink communication and the RSRP measurement of
the cell on which the UE camps (RRC_IDLE)/ the PCell (RRC_CONNECTED) is below
threshHigh within remoteUE-Config :

| | |
|---|---|
| 2> | search for candidate sidelink relay UEs, in accordance with TS 36.133 [16] |
| 2> | when evaluating the one or more detected sidelink relay UEs, apply layer 3 filtering |

as specified in 5.5.3.2 across measurements that concern the same ProSe Relay UE ID and
using the filterCoefficient in SystemInformationBlockType19 (in coverage) or the
preconfigured filterCoefficient as defined in 9.3(out of coverage), before using the SD-RSRP
measurement results;

| | |
|---|---|
| NOTE 1: | The details of the interaction with upper layers are up to UE implementation. |

| | |
|---|---|
| 2> | if the UE does not have a selected sidelink relay UE: |
| 3> | select a candidate sidelink relay UE which SD-RSRP exceeds q-RxLevMin included in |

either reselectionInfoIC (in coverage) or reselectionInfoOoC (out of coverage) by minHyst;

| | |
|---|---|
| 2> | else if SD-RSRP of the currently selected sidelink relay UE is below q-RxLevMin |

included in either reselectionInfoIC (in coverage) or reselectionInfoOoC (out of coverage); or
if upper layers indicate not to use the currently selected sidelink relay: (i.e. sidelink relay UE
reselection):

| | |
|---|---|
| 3> | select a candidate sidelink relay UE which SD-RSRP exceeds q-RxLevMin included in |

either reselectionInfoIC (in coverage) or reselectionInfoOoC (out of coverage) by minHyst;

| | |
|---|---|
| 2> | else if the UE did not detect any candidate sidelink relay UE which SD-RSRP exceeds |

q-RxLevMin included in either reselectionInfoIC (in coverage) or reselectionInfoOoC (out of
coverage) by minHyst:

| | |
|---|---|
| 3> | consider no sidelink relay UE to be selected; |

| | |
|---|---|
| NOTE 2: | The UE may perform sidelink relay UE reselection in a manner resulting in |

selection of the sidelink relay UE, amongst all candidate sidelink relay UEs meeting higher
layer criteria, that has the best radio link quality. Further details, including interaction with
upper layers, are up to UE implementation.

| | |
|---|---|
| 5.10.11.5 | Sidelink remote UE threshold conditions |

A UE capable of sidelink remote UE operation shall:

| | |
|---|---|
| 1> | if the threshold conditions specified in this clause were not met: |
| 2> | if threshHigh is not included in remote UE-Config within |

SystemInformationBlockType19; or

| | |
|---|---|
| 2> | if threshHigh is included in remoteUE-Config within SystemInformationBlockType19; |

and the RSRP measurement of the PCell, or the cell on which the UE camps, is below
threshHigh by hystMax (also included within remoteUE-Config):

| | |
|---|---|
| 3> | consider the threshold conditions to be met (entry); |

else:

| | |
|---|---|
| 2> | if threshHigh is included in remoteUE-Config within SystemInformationBlockType19; |

and the RSRP measurement of the PCell, or the cell on which the UE camps, is above
threshHigh (also included within remoteUE-Config):

| | |
|---|---|
| 3> | consider the threshold conditions not to be met (leave); |

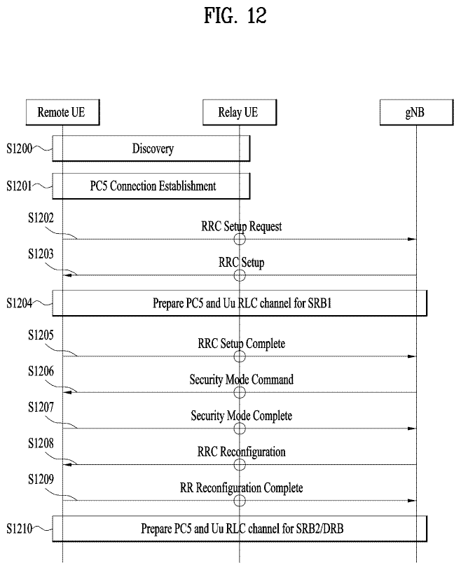

FIG. 12 shows connection management captured in the TR document (3GPP TR 38.836) related to Rel-17 NR SL and a procedure for path switching from direct to indirect. A remote UE needs to establish its own PDU session/DRB with a network before user plane data transmission.

A PC5 unicast link establishment procedure in terms of PC5-RRC of Rel-16 NR V2X may be reused to establish a secure unicast link for L2 UE-to-network relaying between the remote UE and a relay UE before the remote UE establishes a Uu RRC connection with the network through the relay UE.

For both in-coverage and out-of-coverage, when the remote UE initiates a first RRC message for connection establishment with a gNB, a PC5 L2 configuration for transmission between the remote UE and the UE-to-network relay UE may be based on an RLC/MAC configuration defined in the standard. Establishment of Uu SRB1/SRB2 and DRB of the remote UE complies with a legacy Uu configuration procedure for L2 UE-to-network relay.

A high-level connection establishment procedure shown in FIG. 12 is applied to the L2 UE-to-network relay.

In operation S1200, the remote and relay UEs may perform a discovery procedure and establish a PC5-RRC connection in operation S1201 based on the existing Rel-16 procedure.

In operation S1202, the remote UE may transmit a first RRC message (i.e., RRCSetupRequest) for connection establishment with the gNB through the relay UE by using a default L2 configuration of PC5. The gNB responds to the remote UE with an RRCSetup message (S1203). Transmission of RRCSetup to the remote UE uses a default configuration of PC5. When the relay UE does not start in RRC_CONNECTED, the relay UE needs to perform its own connection setup upon receiving a message about the default L2 configuration of PC5. In this operation, details for the relay UE to transmit the RRCSetupRequest/RRCSetup message to the remote UE may be discussed in stage WI.

In operation S1204, the gNB and the relay UE perform a relay channel setup procedure via Uu. According to the configuration of the gNB, the relay/remote UE establishes an RLC channel for relaying SRB1 with the remote UE via PC5. In this operation, a relay channel for SRB1 is prepared.

In operation S1205, the remote UE SRB1 message (e.g., RRCSetupComplete message) is transmitted to the gNB via the relay UE by using the SRB1 relay channel via PC5. The remote UE performs RRC connection via Uu.

In operation S1206, the remote UE and the gNB configure security according to a legacy procedure, and a security message is transmitted through the relay UE.

In operation S1210, the gNB configures an additional RLC channel between the gNB and the relay UE for traffic relay. According to the configuration of the gNB, the relay/remote UE configures an RLC channel between the remote UE and the relay UE for traffic relay. The gNB transmits RRCReconfiguration to the remote UE through the relay UE to configure relay SRB2/DRB. The remote UE transmits RRCReconfigurationComplete in response to the gNB through the relay UE.

For L2 UE-to-network relay in addition to connection establishment procedure:
The RRC reconfiguration and RRC disconnection procedures may reuse legacy RRC procedures with the message content/configuration design left to stage WI.
RRC connection reconfiguration and RRC connection resumption procedures may reuse the existing RRC procedure as a baseline by considering the connection establishment procedure of the above L2 UE-to-network relay to handle a relay-specific part along with message content/configuration design. The message content/configuration may be defined later.

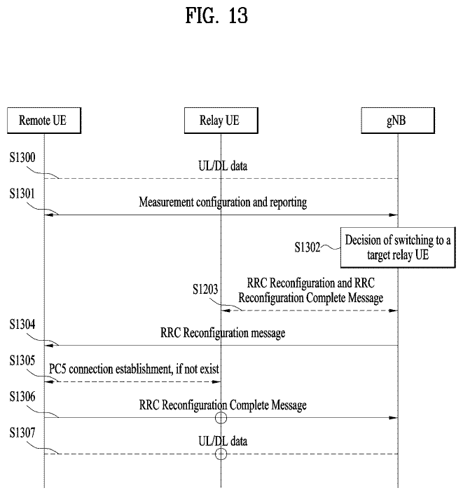

FIG. 13 illustrates direct to indirect path switching. For service continuity of L2 UE-to-network relay, the procedure in FIG. 13 may be used when a remote UE switches to an indirect relay UE.

Referring to FIG. 13, in operation S1301, the remote UE measures/discovers a candidate relay UE and then reports one or several candidate relay UEs. The remote UE may filter out an appropriate relay UE that meets higher layer standard during reporting. The report may include the ID and SL RSRP information of the relay UE, and in this case, the PC5 measurement details may be determined later.

In operation S1302, the gNB determines to switch to a target relay UE and the target (re)configuration is optionally transmitted to the relay UE.

In operation S1304, the RRC reconfiguration message for the remote UE may include the ID of the target relay UE, target Uu, and PC5 configuration.

In operation S1305, the remote UE establishes a PC5 connection with the target relay UE when the connection is not established.

In operation S1306, the remote UE feeds back RRCReconfigurationComplete to the gNB via a target path by using the target configuration provided in RRCReconfiguration. In operation S1307, a data path is switched.

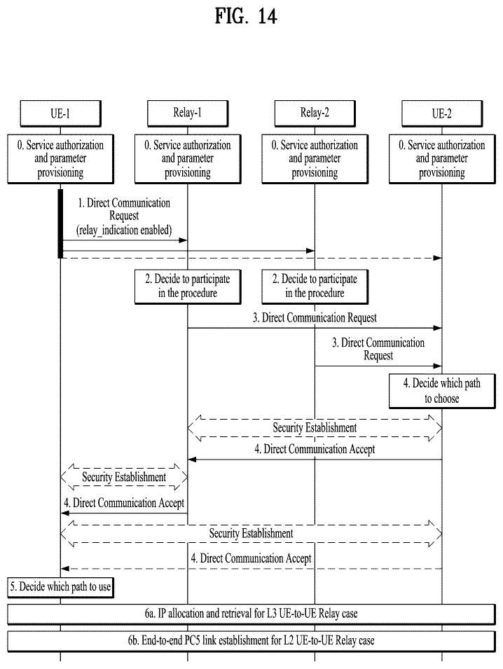

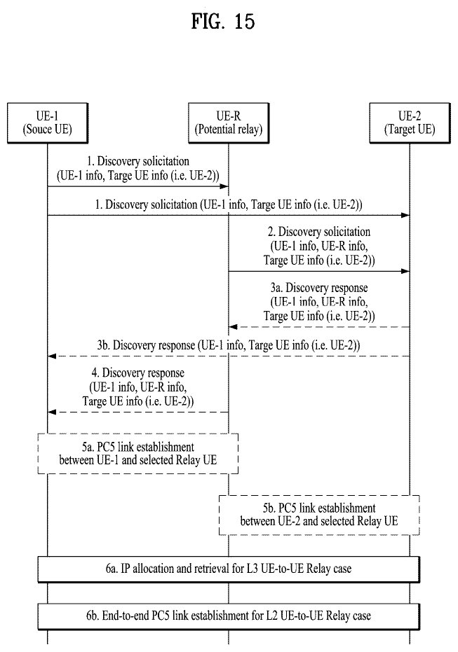

Tables 13 to 16 are a 3GPP technical report related to UE-to-UE relay selection and used as prior art in the present disclosure. FIG. 14 in Table 14 and FIG. 15 in Table 16 correspond to FIG. 14 and FIG. 15, respectively.

TABLE 13

| | |
|---|---|
| 6.8 | Solution #8: UE-to-UE Relay Selection Without Relay Discovery |
| 6.8.1 | Description |

When a source UE wants to communicate with a target UE, it will first try to find the
target UE by either sending a Direct Communication Request or a Solicitation message
with the target UE info. If the source UE cannot reach the target UE directly, it will try
to discover a UE-to-UE relay to reach the target UE which may also trigger the relay to
discover the target UE. To be more efficient, this solution tries to integrate target UE
discovery and UE-to-UE relay discovery and selection together, including two
alternatives:

| | |
|---|---|
| - | Alternative 1: UE-to-UE relay discovery and selection may be integrated into |

the unicast link establishment procedure as described in clause 6.3.3 of TS 23.287 [5].

| | |
|---|---|
| - | Alternative 2: UE-to-UE relay discovery and selection is integrated into Model |

B direct discovery procedure.
A new field is proposed to be added in the Direct Communication Request or the
Solicitation message to indicate whether relays may be used in the communication. The
field may be called relay_indication. When a UE wants to broadcast a Direct
Communication Request or a Solicitation message, it indicates in the message whether
a UE-to-UE relay could be used. For Release 17, it is assumed that the value of the
indication is restricted to single hop.
When a UE-to-UE relay receives a Direct Communication Request or a Solicitation
message with the relay_indication set, then it shall decide whether to forward the
message (i.e. modify the message and broadcast it in its proximity), according to e.g.
Relay Service Code if there is any, Application ID, authorization policy (e.g. relay for
specific ProSe Service), the current traffic load of the relay, the radio conditions
between the source UE and the relay UE, etc.
It may exist a situation where multiple UE-to-UE relays may be used to reach the target
UE or the target UE may also directly receive the Direct Communication Request or
Solicitation message from the source UE. The target UE may choose which one to reply
according to e.g. signal strength, local policy (e.g. traffic load of the UE-to-UE relays),
Relay Service Code if there is any or operator policies (e.g. always prefer direct
communication or only use some specific UE-to-UE relays).
The source UE may receive the responses from multiple UE-to-UE relays and may also
from the target UE directly, the source UE chooses the communication path according
to e.g. signal strength or operator policies (e.g. always prefer direct communication or
only use some specific UE-to-UE relays).

TABLE 14

| | |
|---|---|
| 6.8.2 | Procedures |

6.8.2.1 UE-to-UE relay discovery and selection is integrated into the unicast link
establishment procedure (Alternative 1)
Fig 14 illustrates the procedure of the proposed method.

| | |
|---|---|
| 0. | UEs are authorized to use the service provided by the UE-to-UE relays. UE-to- |

UE relays are authorized to provide service of relaying traffic among UEs. The
authorization and the parameter provisioning may use solutions for KI#8, e.g. Sol#36.
The authorization may be done when UEs/relays are registered to the network. Security
related parameters may be provisioned so that a UE and a relay may verify the
authorization with each other if needed.

| | |
|---|---|
| 1. | UE-1 wants to establish unicast communication with UE-2 and the |

communication may be either through direct link with UE-2 or via a UE-to-UE relay.
Then UE-1 broadcasts Direct Communication Request with relay_indication enabled.
The message will be received by relay-1, relay-2. The message may also be received by
UE-2 if it is in the proximity of UE-1. UE-1 includes source UE info, target UE info,
Application ID, as well as Relay Service Code if there is any. If UE-1 does not want
relay to be involved in the communication, then it will made relay_indication disabled.

| | |
|---|---|
| NOTE 1: | The data type of relay_indication may be determined in Stage 3. Details |

of Direct Communication Request/Accept messages will be determined in stage 3.

| | |
|---|---|
| 2. | Relay-1 and relay-2 decide to participate in the procedure. They broadcast a |
| | new Direct Communication Request message in their proximity without |
| | relay_indication enabled. If a relay receives this message, it will just drop it. When a |
| | relay broadcasts the Direct Communication Request message, it includes source UE |
| | info, target UE info and Relay UE info (e.g. Relay UE ID) in the message and use |
| | Relay's L2 address as the source Layer-2 ID. The Relay maintains association between |
| | the source UE information (e.g. source UE L2 ID) and the new Direct Communication |
| | Request. |
| 3. | UE-2 receives the Direct Communication Requests from relay-1 and relay-2. |
| | UE-2 may also receive Direct Communication Request message directly from the UE-1 |
| | if the UE-2 is in the communication range of UE-1. |
| 4. | UE-2 chooses relay-1 and replies with Direct Communication Accept message. |
| | If UE-2 directly receives the Direct Communication Request from UE-1, it may choose |
| | to setup a direct communication link by sending the Direct Communication Accept |
| | message directly to UE-1. After receiving Direct Communication Accept, a UE-to-UE |
| | relay retrieves the source UE information stored in step 2 and sends the Direct |
| | Communication Accept message to the source UE with its Relay UE info added in the |
| | message. |

TABLE 15
After step 4, UE-1 and UE-2 have respectively setup the PC5 links with the chosen UE-
to-UE relay.

| | |
|---|---|
| NOTE 2: | The security establishment between the UE1 and Relay-1, and between |

Relay-1 and UE-2 are performed before the Relay-1 and UE-2 send Direct
Communication Accept message. Details of the authentication/ security establishment
procedure are determined by SA WG3. The security establishment procedure may be
skipped if there already exists a PC5 link between the source (or target) UE and the
relay which may be used for relaying the traffic.

| | |
|---|---|
| 5. | UE-1 receives the Direct Communication Accept message from relay-1. UE-1 |

chooses path according to e.g. policies (e.g. always choose direct path if it is possible),
signal strength, etc. If UE-1 receives Direct Communication Accept / Response
message request accept directly from UE-2, it may choose to setup a direct PC5 L2 link
with UE-2 as described in clause 6.3.3 of TS 23.287 [5], then step 6 is skipped.

| | |
|---|---|
| 6a. | For the L3 UE-to-UE Relay case, UE-1 and UE-2 finish setting up the |

communication link via the chosen UE-to-UE relay. The link setup information may
vary depending on the type of relay, e.g. L2 or L3 relaying. Then UE-1 and UE-2 may
communicate via the relay. Regarding IP address allocation for the source/remote UE,
the addresses may be either assigned by the relay or by the UE itself (e.g. link-local IP
address) as defined in clause 6.3.3 of TS 23.287 [5].
6b. For the Layer 2 UE-to-UE Relay case, the source and target UE may setup an end-
to-end PC5 link via the relay. UE-1 sends a unicast E2E Direct Communication
Request message to UE-2 via the Relay-1, and UE-2 responds with a unicast E2E
Direct Communication Accept message to UE-1 via the Relay-1. Relay-1 transfers the
messages based on the identity information of UE-1/UE-2 in the Adaptation Layer.

| | |
|---|---|
| NOTE 3: | How Relay-1 may transfer the messages based on the identity |

information of UE-1/UE-2 in the Adaptation Layer requires cooperation with RAN2
during the normative phase.

| | |
|---|---|
| NOTE 4: | In order to make a relay or path selection, the source UE may setup a |

timer after sending out the Direct Communication Request for collecting the
corresponding response messages before making a decision. Similarly, the target UE
may also setup a timer after receiving the first copy of the Direct Communication
Request / message for collecting multiple copies of the message from different paths
before making a decision.

| | |
|---|---|
| NOTE 5: | In the first time when a UE receives a message from a UE-to-UE relay, |

the UE needs to verify if the relay is authorized be a UE-to-UE relay. Similarly, the
UE-to-UE relay may also need to verify if the UE is authorized to use the relay service.
The verification details and the how to secure the communication between two UEs
through a UE-to-UE relay is to be defined by SA WG3.

TABLE 16
6.8.2.2 UE-to-UE relay discovery and selection is integrated into Model B direct
discovery procedure (Alternative 2)
Depicted in Fig 15 is the procedure for UE-UE Relay discovery Model B, and the
discovery/selection procedure is separated from hop by hop and end-to-end link
establishment.

| | |
|---|---|
| 1. | UE-1 broadcasts discovery solicitation message carrying UE-1 info, target UE |

info (UE-2), Application ID, Relay Service Code if any, the UE-1 may also indicate
relay_indication enabled.

| | |
|---|---|
| 2. | On reception of discovery solicitation, the candidate Relay UE-R broadcasts |

discovery solicitation carrying UE-1 info, UE-R info, Target UE info. The Relay UE-R
uses Relay's L2 address as the source Layer-2 ID.

| | |
|---|---|
| 3. | The target UE-2 responds the discovery message. If the UE-2 receives |

discovery solicitation message in step 1, then UE-2 responds discovery response in step
3b with UE-1 info, UE-2 info. If not and UE-2 receives discovery solicitation in step 2,
then UE-2 responds discovery response message in step 3a with UE-1 info, UE-R info,
UE-2 info.

| | |
|---|---|
| 4. | On reception of discovery response in step 3a, UE-R sends discovery response |

with UE-1 info, UE-R info, UE-2 info. If more than one candidate Relay UEs
responding discovery response message, UE-1 may select one Relay UE based on e.g.
implementation or link qualification.

| | |
|---|---|
| 5. | The source and target UE may need to setup PC5 links with the relay before |

communicating with each other. Step 5a may be skipped if there already exists a PC5
link between the UE-1 and UE-R which may be used for relaying. Step 5b may be
skipped if there already exists a PC5 link between the UE-2 and UE-R which may be
used for relaying.

| | |
|---|---|
| 6a. | Same as step 6a described in clause 6.8.2.1. |
| 6b. | For the Layer-2 UE-to-UE Relay, the E2E unicast Direct Communication |

Request message is sent from UE1 to the selected Relay via the per-hop link
(established in steps 5a) and the Adaptation layer info identifying the peer UE (UE3) as
the destination. The UE-to-UE Relay transfers the E2E messages based on the identity
information of peer UE in the Adaptation Layer. The initiator (UE1) knows the
Adaptation layer info identifying the peer UE (UE3) after a discovery procedure. UE3
responds with E2E unicast Direct Communication Accept message in the same way.
NOTE 1: For the Layer 2 UE-to-UE Relay case, whether step5b is performed before
step 6b or triggered during step 6b will be decided at normative phase.
NOTE 2: How Relay-1 may transfer the messages based on the identity information of
UE-1/UE-2 in the Adaptation Layer requires cooperation with RAN2 during the
normative phase.

| | |
|---|---|
| 6.8.3 | Impacts on services, entities and interfaces |

UE impacts to support new Relay related functions.

Table 17 describes a work item description (WID) related to NR sidelink relay enhancements and agreements related to the present disclosure, which are used as prior art in the present disclosure.

TABLE 17
3. Study the benefit and potential solutions for multi-path support to enhance reliability
and throughput (e.g., by switching among or utilizing the multiple paths
simultaneously) in the following scenarios [RAN2, RAN3]:

| | |
|---|---|
| A. | A UE is connected to the same gNB using one direct path and one indirect path |

via 1) Layer-2 UE-to-Network relay, or 2) via another UE (where the UE-UE inter-
connection is assumed to be ideal), where the solutions for 1) are to be reused for 2)
without precluding the possibility of excluding a part of the solutions which is
unnecessary for the operation for 2).
Note 3A: Study on the benefit and potential solutions are to be completed in RAN#98
which will decide whether/how to start the normative work.
Note 3B: UE-to-Network relay in scenario 1 reuses the Rel-17 solution as the baseline.
Note 3C: Support of Layer-3 UE-to-Network relay in multi-path scenario is assumed to
have no RAN impact and the work and solutions are subject to SA2 to progress.
(113e) Alignment of Uu DRX and SL DRX for UE in RRC CONNECTED shall be a
baseline.
(114e) For SL unicast, TX-UE centric DRX configuration based on the assistance
information from RX-UE is agreed as baseline.
(114e) Alignment of Uu DRX and SL DRX for UE may comprise the full overlapping
between Uu DRX and SL DRX in time.
(114e) Alignment of Uu DRX and SL DRX for UE may comprise the partial
overlapping between Uu DRX and SL DRX in time.
(114e) For at least SL RX-UEs in RRC CONNECTED, the alignment of Uu DRX and
SL DRX is up to gNB. FFS for SL TX-UE.
(114e) RAN2 to down-scope alignment of Uu DRX and SL DRX for UEs in RRC
IDLE and RRC INACTIVE from Rel-17.
(114e) In case of Mode 1 scheduling, the alignment of Uu DRX of Tx UE and SL DRX
of Rx UE shall be considered. FFS on how alignment is achieved.
(115e) For determining SL DRX configuration by TX UE, SL DRX capable RX UE is
not mandatory to provide the SL DRX assistance information to TX UE. FFS on the
interpretation if assistance information is not provided.
(115e) For SL unicast, RX UE may include its desired SL DRX configuration in the
assistance information which is transmitted to TX UE.
(117e) (Add a NOTE that Tx-UE derives the DRX setting by taking assistance
information into account (detailed wording left to RRC running-CR discussion).
(116bis-e) For unicast and TX UE in RRC CONNECTED and Mode 1 RA, the serving
gNB of TX UE determines the SL DRX configurations for RX UE.
(116bis-e) For unicast and TX UE in RRC CONNECTED and Mode 2 RA, TX UE
determines SL DRX for RX UE.
(116bis-e) UE reports sidelink assistance information to its serving gNB, upon
receiving sidelink DRX assistance information from the peer UE

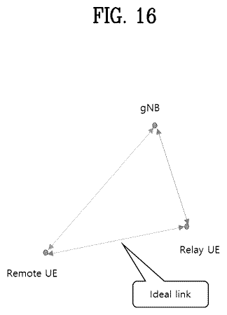

Meanwhile, the remote UE may activate both a direct path and an indirect path through the relay UE in relation to signal transmission and reception to and from the gNB, and the connection between the remote UE and the relay UE may be an ideal link as illustrated in FIG. 16, unlike existing SL-relay. Hereinbelow, the present disclosure mainly discloses various operations that may occur, when a link between a remote UE and a relay UE is ideal.

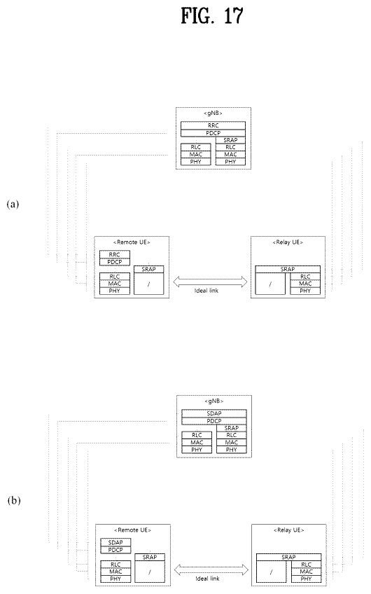

In relation to the above ideal link, when the remote UE and the relay UE are connected via the ideal link, such a protocol stack as illustrated in FIG. 17 may be considered. FIG. 17(a) illustrates a multi-path relay protocol stack (control plane), when a remote UE and a relay UE are connected via an ideal path, and FIG. 17(b) illustrates a multi-path relay protocol stack (user plane), when the remote UE and the relay UE are connected via the ideal path. In addition, the SRAP layer in FIG. 17 may be a layer that performs a new function different from the SRAP used in an existing U2N relay. As noted from the exemplary protocol stacks illustrated in FIG. 17, the 3GPP radio access technology (RAT) is used/applied between the gNB and the relay UE and between the gNB and the remote UE, but the 3GPP RAT is not applied/used between the relay UE and the remote UE. That is, the ideal link connection may correspond to a non-3GPP RAT. For example, the non-3GPP RAT may be one of various conventional communication schemes such as Bluetooth, Wi-Fi, and Zigbee.

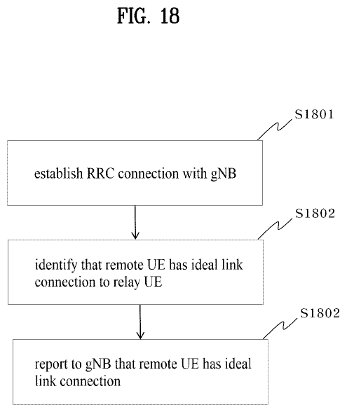

A remote UE according to an embodiment of the present disclosure may establish an RRC connection with a gNB (S1801 in FIG. 18), identify/know/recognize/distinguish that the remote UE has an ideal link connection to a relay UE (S1802), and report to the gNB that the remote UE has the ideal link connection (S1803).

Based on having the ideal link connection, the remote UE may ignore a configuration related to a multi-path relay operation, received from the gNB. That is, the relay UE and the remote UE may notify the gNB of a link ID of an ideal link, and upon receipt of the link ID, the gNB may identify that the relay UE and the remote UE are connected via the ideal link. Upon receipt of the link ID, the gNB may not perform an SL-related configuration during a relay operation. Alternatively, even if the gNB performs the configuration related to the relay operation, the relay/remote UE may not apply it, while ignoring it.

The configuration related to the multi-path relay operation may include one or more of:
1) a QoS split configuration,
2) a relay-related SL bearer configuration,
3) an SL (discovery/communication-related) pool configuration,
4) related grant information in the case of operation in Model,
5) a measurement report for a candidate relay UE, and
6) a bearer mapping-related configuration (indicating SL bear to Uu bearer mapping information for a relay UE).

That is, the gNB may not perform the above configuration for the remote/relay UE, or even if the gNB performs the related configuration, the remote/relay UE may not perform/apply it. Alternatively, the remote/relay UE may perform an operation of not expecting the configuration for the link.

Even if the remote/relay UE indicates by SUI that the remote UE and the relay UE are connected via the ideal link, the gNB may configure the following information for the relay UE. That is, even if the remote UE has the ideal link connection, the gNB may configure the relay UE with at least one of a Uu data bearer required to forward data of the remote UE, a local ID to be used for transmitting data of the remote UE between the relay UE and the gNB, information related to a HO command, or information related to a HO failure. The HO command and the HO failure may be related to HO of the remote UE and the relay UE to the same gNB. More specifically, when the gNB issues the HO command to the relay or the remote UE, the gNB may transmit the HO command to both UEs so that the relay UE and the remote UE may be connected to the same gNB (and/or cell). In this case, when one of the remote UE and the relay UE fails in the HO, the gNB may inform the UE succeeding in the HO out of the relay UE and the remote UE that the other UE connected to the ideal link failed in the HO.

As such, as the remote UE and the relay UE indicate to the gNB that they are connected via the ideal link, they may avoid allocation of an unnecessary configuration to them. In addition, even if receiving the unnecessary configuration, they may exceptionally perform an operation of not applying the configuration.

Meanwhile, when the remote UE and the relay UE are connected via the ideal link, the remote (and/or the relay UE) may indicate to the gNB by SUI that they are connected via the ideal link. A higher layer of the remote UE (and/or the relay UE) may indicate whether the remote UE and the relay UE are connected via the ideal link.

In this case, the higher layers of the remote UE and the relay UE may also assign an SRC (L2) ID and a DST (L2) ID to AS layers.

(Alternatively) the higher layer of the remote UE (and/or the relay UE) may indicate the link ID of the ideal link to the AS layer.

(Alternatively) when the higher layer indicates to the RRC layer that the remote UE and the relay UE are connected via the ideal link, the RRC layer may allocate the link ID.

The remote/relay UE may also inform the gNB of the SRC (L2) ID and the DST (L2) assigned by the higher layer, while indicating by the SUI that the remote UE and the relay UE are connected via the ideal link. That is, the above report may include the SRC ID (source ID) and the DST ID (destination ID) assigned by the higher layer. Alternatively, the link ID may be indicated by the SUI. That is, the relay UE and the remote UE may indicate the link ID of the ideal link to the gNB (by the same value). Upon receipt of the link ID, the gNB may identify that the relay UE and the remote UE are connected via the ideal link.

In relation to the above description, a remote UE may include at least one processor, and at least one computer memory operably connected to the at least one processor and storing instructions that, when executed, cause the at least one processor to perform operations. The operations may include establishing an RRC connection with a gNB by the remote UE, identifying that the remote UE has an ideal link connection to a relay UE by the remote UE, reporting to the gNB that the remote UE has the ideal link connection by the remote UE. The remote UE may ignore a configuration related to a multi-path relay operation, received from the gNB, based on having the ideal link connection. The remote UE may communicate with at least one of another UE, a UE related to an autonomous driving vehicle, a gNB, or a network.

Table 18 below relates to NR sidelink U2N relay UE threshold conditions, which is used as prior art of the present disclosure.

TABLE 18

| 5.8.14 NR sidelink U2N Relay UE operation | |
|---|---|
| 5.8.14.1 | General |

This procedure is used by a UE supporting NR sidelink U2N Relay UE

operation configured by upper layers to receive/ transmit NR sidelink discovery
messages to evaluate AS layer conditions.

| | |
|---|---|
| 5.8.14.2 | NR sidelink U2N Relay UE threshold conditions |

| A UE capable of NR sidelink U2N Relay UE operation shall: | |
|---|---|
| 1> | if the threshold conditions specified in this clause were not met: |
| 2> | if threshHighRelay is not configured; or the RSRP measurement of the |

PCell, or the cell on which the UE camps, is below threshHighRelay by hystMaxRelay
if configured; and

| | |
|---|---|
| 2> | if threshLowRelay is not configured; or the RSRP measurement of the |

PCell, or the cell on which the UE camps, is above threshLowRelay by hystMinRelay if
configured:

| | |
|---|---|
| 3> | consider the threshold conditions to be met (entry); |
| 1> | else: |
| 2> | if the RSRP measurement of the PCell, or the cell on which the UE |

camps, is above threshHighRelay if configured; or

| | |
|---|---|
| 2> | if the RSRP measurement of the PCell, or the cell on which the UE |

camps, is below threshLowRelay if configured;
3> consider the threshold conditions not to be met (leave);

Multi-path relay may serve a different purpose from U2N relay. A U2N relay UE may be used for power saving and coverage extension of a remote UE. However, a multi-path relay UE may be used for the purpose of increasing a threshold or reliability of data transmitted by a remote UE. Therefore, the purpose of transmitting a discovery message by the U2N relay UE may be different from the purpose of transmitting a discovery message by the multi-path relay UE. Hereinbelow, another embodiment of the present disclosure discloses a condition for triggering transmission of a discovery message from a multi-path relay UE and the contents of the discovery message.

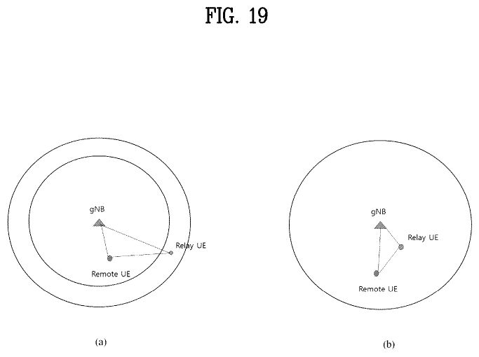

A threshold for transmitting the discovery message by the U2N relay UE may have a different value from a threshold for a Uu link signal strength for transmitting the discovery message by the multi-path relay UE. A threshold reference for the Uu link signal strength for transmitting the discovery message by the U2N relay UE corresponds to a donut-shaped boundary of gNB coverage (at which the Uu link signal strength is between threshold_A and threshold_B), as illustrated in FIG. 19(a). This is because the purpose of the U2N relay UE is to extend the coverage.

However, in the case of a multi-path relay operation, a relay UE having a larger Uu link signal strength than the remote UE may be preferably selected. Since the multi-path relay operation is for increasing throughput and reliability via an indirect path, when the signal strength of the Uu link of the relay UE is less than that of the Uu link of the remote UE, the purpose of the multi-path relay operation may not be fulfilled. Therefore, since data is transmitted via an SL and a Uu link between the relay UE and the gNB in the multi-path operation, the indirect link should have a larger signal strength than the direct link of the remote UE to achieve a desired purpose (FIG. 19(b)). When the Uu and SL signal strengths of the relay UE are weak, it may be favorable for the remote UE to transmit a signal to the gNB only via the direct link. Accordingly, a threshold for a Uu link signal strength, for triggering transmission of a discovery message from the relay UE used in the multi-path relay operation may need to have a different value from a threshold for a Uu link signal strength, for triggering transmission of a discovery message from the N2N relay UE.

When the relay UE is RRC CONNECTED, the gNB may configure the relay UE to transmit a discovery message for a multi-path by RRC dedicated signaling. Alternatively, a threshold for a Uu link signal strength for multi-path discovery, which triggers the relay UE to transmit the discovery message for the multi-path, may be set in SIB information. The gNB may configure whether the relay UE will operate as a U2N relay UE, a multi-path relay UE, or both, by a dedicated RRC message. In this case, the AS layer may inform the higher layer of this. The higher layer may indicate this in the discovery message based on the information provided by the AS layer. For example, a service code field of the discovery message may indicate differently whether it is a discovery message for U2N, a discovery message for a multi-path, or a discovery message to support both.

When the Uu link signal strength satisfies the multi-path threshold condition, the (IDLE/INACTIVE) relay UE may transmit a discovery message with a service code indicating that it is a discovery message for multi-path relay. When the Uu link U2N threshold condition is satisfied, the relay UE may transmit a discovery message with a service code indicating that it is a discovery message for U2N relay. When the Uu link signal strength satisfies both the threshold for the multi-path relay operation and the threshold for the U2N relay operation, the relay UE may transmit a discovery message with a service code indicating that it is a discovery message satisfying both U2N relay and multi-path relay. Upon receipt of the discovery message, when transmitting a DCR message, the remote UE may add the DCR message with an indication indicating for which relay UE operation (U2N or multi-path) the DCR message establishes an SL.

When the remote UE transmits a solicitation message to the relay UE (using discovery model B), the remote UE may indicate a relay operation supported by a relay UE that it is searching for. In this case, the service code may be used for the indication as well. Upon receipt of the solicitation message, the relay UE may transmit a response message to the received message, only when it is capable of transmitting a discovery message with the same service code as the service code included in the discovery message transmitted by the remote UE.

When the relay UE operates as a multi-path relay UE and then changes to operate as a U2N relay UE (e.g. due to a change in its Uu signal strength value), the relay UE may indicate this to the gNB and/or the remote UE.
Upon receipt of the indication, the gNB may determine that there is no gain from the multi-path operation, and configure RRCReconfiguration for the remote UE and the relay UE to release the multi-path operation from the remote UE and the relay UE, (while maintaining only the direct link).
Upon receipt of the RRCReconfiguration, the remote UE may determine that there is no gain from multi-path operation, release the multi-path operation with the relay UE, and report the release to the gNB via the direct link. Alternatively, the remote UE may maintain the indirect link as it is, and transmit ongoing data only through the direct link.
When the relay UE operates as a U2N relay UE and then changes to operate as a multi-path relay UE (e.g., due to a change in its Uu signal strength value), the relay UE may indicate this to the gNB or the remote UE.
Upon receipt of the indication, the gNB may configure the remote UE to measure and report (a direct link for a current serving cell). Alternatively, if there is a previously reported measurement value of the direct link, the gNB may perform a configuration for a multi-path operation for the remote UE.
When the remote UE receives the configuration, thus may trigger the measurement and report of the direct link. When the gNB determines that the remote UE is capable of the multi-path operation, based on a (direct link) measurement result from the remote UE, the gNB may configure RRCReconfiguration for a multi-path.

Table 19 below is part of the contribution S2-2206110 related to Tx profiles Clarifications for default SL DRX, and the disclosed contents are used as prior art of the present disclosure.

TABLE 19

| | |
|---|---|
| 5.9 | Support of QoS aware NR PC5 power efficiency for pedestrian UEs |

For NR based unicast, groupcast and broadcast mode communication over PC5

reference point, PC5 DRX operations are supported to enable pedestrian UE power
saving.

The V2X layer determines the respective V2X service types, and derives the

corresponding PC5 QoS parameters based on either the mapping of V2X service types
to PC5 QoS parameters, or the V2X Application Requirements for the V2X service
type provided by the application layer. The V2X layer passes the PC5 QoS parameters
and destination Layer-2 ID to the AS layer as specified in clauses 6.3.1, 6.3.2 and 6.3.3.
When the V2X layer derives new PC5 QoS parameters for a destination Layer-2 ID that
has been provided to the AS layer, i.e. due to changes of V2X service types or V2X
Application Requirements, the V2X layer provides the new PC5 QoS parameters for
the destination Layer-2 ID to the AS layer.

| | |
|---|---|
| NOTE 1: | For broadcast and groupcast, the AS layer needs PC5 QoS |

parameters as well to determine the PC5 DRX parameter values for reception operation
over PC5 reference point. Therefore, the V2X layer determines the interested V2X
service types and derives the PC5 QoS parameters based on its reception needs besides
the transmission needs. How to derive the PC5 QoS parameters based on its reception
needs (e.g. without establishing the PC5 QoS Flows) depends on UE implementation.

For broadcast and groupcast, the V2X layer determines the NR Tx Profile for

the respective V2X service type based on the configuration described in clause 5.1.2.1
and provides the NR Tx Profile to the AS layer as specified in clauses 6.3.1 and 6.3.2.
When there is no NR Tx Profile available to be mapped for the respective V2X service
type, the V2X layer does not provide NR Tx Profile to the AS layer.

For broadcast, the mapping from destination Layer-2 ID to NR Tx Profile is

configured in the NG-RAN. The NG-RAN may derive the NR Tx Profile from the
destination Layer-2 ID to perform the network scheduled operation mode, alignment of
Uu DRX and PC5 DRX, etc.

Support for PC5 DRX operations in the AS layer is specified in TS 38.300

[11].

When the PC5 DRX operation is needed, e.g. based on the NR Tx Profile in

case of broadcast or groupcast, the AS layer determines the PC5 DRX parameter values
for V2X communication over PC5 reference point, taking into account, e.g., PC5 QoS
parameters and/or destination Layer-2 ID provided by the V2X layer.

For unicast, two UEs may negotiate the PC5 DRX configuration in the AS

layer, and the PC5 DRX parameter values can be configured per pair of source and
destination Layer-2 IDs and per direction in the AS layer. For transmitting and
receiving Direct Communication Request messages, the default PC5 DRX
configuration is used if the corresponding NR Tx Profiles has been configured. The
NG-RAN may deduce the NR Tx Profile from the destination Layer-2 ID if the
network scheduled operation mode is used.

| | |
|---|---|
| NOTE 2: | The mapping from destination Layer-2 ID to NR Tx Profile is |

configured in the NG-RAN.
For broadcast and groupcast when the UE is “not served by E-UTRA” and “not served
by NR”, the UE uses the provisioned PC5 DRX configuration for PC5 DRX operation
as specified in clause 5.1.2.1.

As disclosed in Table 18 above, the Direct Communication Request (DCR) message mentioned in Table 13 may be transmitted by applying SL-DRX. The following Tables 20 to 24 are related to the sidelink DRX disclosed in 3GPP TS 38.321 V16.2.1 and used as prior art of the present disclosure. In addition, the SidelinkUEInformationNR information element disclosed in 3GPP TS 38.331 is also used as prior art of the present disclosure, and for details, refer to the 3GPP TS 38.331 standard document.

TABLE 20
The MAC entity may be configured by RRC with a DRX functionality that controls the UE's
PDCCH monitoring activity for the MAC entity's C-RNTI, CI-RNTI, CS-RNTI, INT-RNTI,
SFI-RNTI, SP-CSI-RNTI, TPC-PUCCH-RNTI, TPC-PUSCH-RNTI, TPC-SRS-RNTI, and
AI-RNTI. When using DRX operation, the MAC entity shall also monitor PDCCH according
to requirements found in other clauses of this specification. When in RRC_CONNECTED, if
DRX is configured, for all the activated Serving Cells, the MAC entity may monitor the
PDCCH discontinuously using the DRX operation specified in this clause; otherwise the
MAC entity shall monitor the PDCCH as specified in TS 38.213 [6].

| | |
|---|---|
| NOTE 1: | If Sidelink resource allocation mode 1 is configured by RRC, a DRX |
| | functionality is not configured. |

RRC controls DRX operation by configuring the following parameters:

- drx-onDurationTimer: the duration at the beginning of a DRX cycle;
- drx-SlotOffset: the delay before starting the drx-onDurationTimer;
- drx-InactivityTimer: the duration after the PDCCH occasion in which a PDCCH
indicates a new UL or DL transmission for the MAC entity;
- drx-RetransmissionTimerDL (per DL HARQ process except for the broadcast
process): the maximum duration until a DL retransmission is received;
- drx-RetransmissionTimerUL (per UL HARQ process): the maximum duration until a
grant for UL retransmission is received;
- drx-LongCycleStartOffset: the Long DRX cycle and drx-StartOffset which defines the
subframe where the Long and Short DRX cycle starts;
- drx-ShortCycle (optional): the Short DRX cycle;
- drx-ShortCycleTimer (optional): the duration the UE shall follow the Short DRX
cycle;
- drx-HARQ-RTT-TimerDL (per DL HARQ process except for the broadcast process):
the minimum duration before a DL assignment for HARQ retransmission is expected
by the MAC entity;
- drx-HARQ-RTT-TimerUL (per UL HARQ process): the minimum duration before a
UL HARQ retransmission grant is expected by the MAC entity;
- ps-Wakeup (optional): the configuration to start associated drx-onDurationTimer in
case DCP is monitored but not detected;
- ps-TransmitOtherPeriodicCSI (optional): the configuration to report periodic CSI that
is not L1-RSRP on PUCCH during the time duration indicated by drx-onDurationTimer
in case DCP is configured but associated drx-onDurationTimer is not started;
- ps-TransmitPeriodicL1-RSRP (optional): the configuration to transmit periodic CSI
that is L1-RSRP on PUCCH during the time duration indicated by drx-
onDurationTimer in case DCP is configured but associated drx-onDurationTimer is not
started.

Serving Cells of a MAC entity may be configured by RRC in two DRX groups with separate
DRX parameters. When RRC does not configure a secondary DRX group, there is only one
DRX group and all Serving Cells belong to that one DRX group. When two DRX groups are
configured, each Serving Cell is uniquely assigned to either of the two groups. The DRX
parameters that are separately configured for each DRX group are: drx-onDurationTimer,
drx-InactivityTimer. The DRX parameters that are common to the DRX groups are: drx-
SlotOffset, drx-RetransmissionTimerDL, drx-RetransmissionTimerUL, drx-
LongCycleStartOffset, drx-ShortCycle (optional), drx-ShortCycleTimer (optional), drx-
HARQ-RTT-TimerDL, and drx-HARQ-RTT-TimerUL.
When a DRX cycle is configured, the Active Time for Serving Cells in a DRX group
includes the time while:

| | |
|---|---|
| - | drx-onDurationTimer or drx-InactivityTimer configured for the DRX group is |
| | running; or |
| - | drx-RetransmissionTimerDL or drx-RetransmissionTimerUL is running on any |

Serving Cell in the DRX group;

TABLE 21
or

| | |
|---|---|
| - | ra-ContentionResolutionTimer (as described in clause 5.1.5) or msgB-ResponseWindow |
| | (as described in clause 5.1.4a) is running; or |
| - | a Scheduling Request is sent on PUCCH and is pending (as described in clause 5.4.4); |
| | or |
| - | a PDCCH indicating a new transmission addressed to the C-RNTI of the MAC entity |
| | has not been received after successful reception of a Random Access Response for the |
| | Random Access Preamble not selected by the MAC entity among the contention-based |
| | Random Access Preamble (as described in clauses 5.1.4 and 5.1.4a). |

When DRX is configured, the MAC entity shall:
1>if a MAC PDU is received in a configured downlink assignment:

2>start the drx-HARQ-RTT-TimerDL for the corresponding HARQ process in the first

symbol after the end of the corresponding transmission carrying the DL HARQ
feedback;

2>stop the drx-RetransmissionTimerDL for the corresponding HARQ process.

1>if a MAC PDU is transmitted in a configured uplink grant and LBT failure indication is

not received from lower layers:
2>start the drx-HARQ-RTT-TimerUL for the corresponding HARQ process in the first

symbol after the end of the first repetition of the corresponding PUSCH
transmission;

2>stop the drx-RetransmissionTimerUL for the corresponding HARQ process.

1>if a drx-HARQ-RTT-TimerDL expires:

2>if the data of the corresponding HARQ process was not successfully decoded:

3>start the drx-RetransmissionTimerDL for the corresponding HARQ process in the

first symbol after the expiry of drx-HARQ-RTT-TimerDL.

1>if a drx-HARQ-RTT-TimerUL expires:

2>start the drx-RetransmissionTimerUL for the corresponding HARQ process in the

first symbol after the expiry of drx-HARQ-RTT-Timer UL.

1>if a DRX Command MAC CE or a Long DRX Command MAC CE is received:

2>stop drx-onDurationTimer for each DRX group;
2>stop drx-InactivityTimer for each DRX group.

1>if drx-InactivityTimer for a DRX group expires:

2>if the Short DRX cycle is configured:

3>start or restart drx-ShortCycleTimer for this DRX group in the first symbol after

the expiry of drx-InactivityTimer;

3> use the Short DRX cycle for this DRX group.

2>else:

3>use the Long DRX cycle for this DRX group.

1>if a DRX Command MAC CE is received:

2>if the Short DRX cycle is configured:

3>start or restart drx-ShortCycleTimer for each DRX group in the first symbol after

the end of DRX Command MAC CE reception;

TABLE 22

3>use the Short DRX cycle for each DRX group.

2>else:

3>use the Long DRX cycle for each DRX group.

```
  1>if drx-ShortCycleTimer for a DRX group expires:
    2>use the Long DRX cycle for this DRX group.
  1>if a Long DRX Command MAC CE is received:
    2>stop drx-ShortCycleTimer for each DRX group;
    2>use the Long DRX cycle for each DRX group.
  1>if the Short DRX cycle is used for a DRX group, and [(SFN × 10) + subframe number]
    modulo (drx-ShortCycle) = (drx-StartOffset) modulo (drx-ShortCycle):
    2>start drx-onDurationTimer for this DRX group after drx-SlotOffset from the
```

beginning of the subframe.

```
  1>if the Long DRX cycle is used for a DRX group, and [(SFN × 10) + subframe number]
    modulo (drx-LongCycle) = drx-StartOffset:
    2>if DCP monitoring is configured for the active DL BWP as specified in TS 38.213
```

```
  [6], clause 10.3:
  3>if DCP indication associated with the current DRX cycle received from lower
    layer indicated to start drx-onDurationTimer, as specified in TS 38.213 [6]; or
  3>if all DCP occasion(s) in time domain, as specified in TS 38.213 [6], associated
    with the current DRX cycle occurred in Active Time considering
    grants/assignments/DRX Command MAC CE/Long DRX Command MAC CE
    received and Scheduling Request sent until 4 ms prior to start of the last DCP
    occasion, or within BWP switching interruption length, or during a measurement
    gap, or when the MAC entity monitors for a PDCCH transmission on the search
    space indicated by recoverySearchSpaceId of the SpCell identified by the C-
    RNTI while the ra-ResponseWindow is running (as specified in clause 5.1.4); or
  3>if ps-Wakeup is configured with value true and DCP indication associated with
    the current DRX cycle has not been received from lower layers:
    4>start drx-onDurationTimer after drx-SlotOffset from the beginning of the
      subframe.
```

2>else:

| | |
|---|---|
| | 3>start drx-onDurationTimer for this DRX group after drx-SlotOffset from the |
| | beginning of the subframe. |
| 1. | NOTE 2: In case of unaligned SFN across carriers in a cell group, the SFN of the |
| | SpCell is used to calculate the DRX duration. |

```
  1>if a DRX group is in Active Time:
    2>monitor the PDCCH on the Serving Cells in this DRX group as specified in TS
```

38.213 [6];

2>if the PDCCH indicates a DL transmission:

| | |
|---|---|
| | 3>start the drx-HARQ-RTT-TimerDL for the corresponding HARQ process in the |
| | first symbol after the end of the corresponding transmission carrying the DL |
| | HARQ feedback; |
| 2. | NOTE 3: When HARQ feedback is postponed by PDSCH-to-HARQ_feedback |
| | timing indicating a non-numerical k1 value, as specified in TS 38.213 [6], the |
| | corresponding transmission opportunity to send the DL HARQ feedback is |
| | indicated in a later PDCCH requesting the HARQ-ACK feedback. |
| | 3>stop the drx-RetransmissionTimerDL for the corresponding HARQ process. |
| | 3>if the PDSCH-to-HARQ feedback timing indicate a non-numerical k1 value as |
| | specified in TS 38.213 [6]: |
| | 4>start the drx-RetransmissionTimerDL in the first symbol after the PDSCH |
| | transmission for the corresponding HARQ process. |
| 2> | if the PDCCH indicates a UL transmission: |

TABLE 23

3>start the drx-HARQ-RTT-TimerUL for the corresponding HARQ process in the

first symbol after the end of the first repetition of the corresponding PUSCH
transmission;

3>stop the drx-RetransmissionTimerUL for the corresponding HARQ process.

2>if the PDCCH indicates a new transmission (DL or UL) on a Serving Cell in this

DRX group:
3>start or restart drx-InactivityTimer for this DRX group in the first symbol after the

end of the PDCCH reception.

2>if a HARQ process receives downlink feedback information and acknowledgement

is indicated:
3>stop the drx-RetransmissionTimerUL for the corresponding HARQ process.

```
  1>if DCP monitoring is configured for the active DL BWP as specified in TS 38.213 [6],
    clause 10.3; and
  1>if the current symbol n occurs within drx-onDurationTimer duration; and
  1>if drx-onDurationTimer associated with the current DRX cycle is not started as
    specified in this clause:
    2>if the MAC entity would not be in Active Time considering
```

| | grants/assignments/DRX Command MAC CE/Long DRX Command MAC CE | |
|---|---|---|
| | received and Scheduling Request sent until 4 ms prior to symbol n when evaluating | |
| | all DRX Active Time conditions as specified in this clause: | |
| | 3>not transmit periodic SRS and semi-persistent SRS defined in TS 38.214 [7]; | |
| | 3>not report semi-persistent CSI configured on PUSCH; | |
| | 3>if ps-TransmitPeriodicLI-RSRP is not configured with value true: | |
| | | 4>not report periodic CSI that is L1-RSRP on PUCCH. |
| | 3>if ps-TransmitOtherPeriodicCSI is not configured with value true: | |
| | | 4>not report periodic CSI that is not L1-RSRP on PUCCH. |
| 1>else: | | |

2>in current symbol n, if a DRX group would not be in Active Time considering

grants/assignments scheduled on Serving Cell(s) in this DRX group and DRX
Command MAC CE/Long DRX Command MAC CE received and Scheduling
Request sent until 4 ms prior to symbol n when evaluating all DRX Active Time
conditions as specified in this clause:
3>not transmit periodic SRS and semi-persistent SRS defined in TS 38.214 [7] in

this DRX group;

3>not report CSI on PUCCH and semi-persistent CSI configured on PUSCH in this

DRX group.

2>if CSI masking (csi-Mask) is setup by upper layers:

| | 3>in current symbol n, if drx-onDurationTimer of a DRX group would not be | |
|---|---|---|
| | | running considering grants/assignments scheduled on Serving Cell(s) in this DRX |
| | | group and DRX Command MAC CE/Long DRX Command MAC CE received |
| | | until 4 ms prior to symbol n when evaluating all DRX Active Time conditions as |
| | | specified in this clause; and |
| | | 4>not report CSI on PUCCH in this DRX group. |
| 3. | | NOTE 4: If a UE multiplexes a CSI configured on PUCCH with other |
| | | overlapping UCI(s) according to the procedure specified in TS 38.213 [6] clause |
| | | 9.2.5 and this CSI multiplexed with other UCI(s) would be reported on a PUCCH |
| | | resource outside DRX Active Time of the DRX group in which this PUCCH is |
| | | configured, it is up to UE implementation whether to report this CSI multiplexed |
| | | with other UCI(s). |

Regardless of whether the MAC entity is monitoring PDCCH or not on the Serving Cells in a
DRX group, the MAC entity transmits HARQ feedback, aperiodic CSI on PUSCH, and
aperiodic SRS defined in TS 38.214 [7] on the Serving Cells in the DRX group when such is
expected.
The MAC entity needs not to monitor the PDCCH if it is not a complete PDCCH occasion
(e.g. the Active Time starts or ends in the middle of a PDCCH occasion).

Table 24 below is part of Rel-17 V2X WID (RP-201385).

TABLE 24
4.1 Objective of SI or Core part WI or Testing part WI
The objective of this work item is to specify radio solutions that can enhance NR sidelink for
the V2X, public safety and commercial use cases.
1. Sidelink evaluation methodology update: Define evaluation assumption and performance
metric for power saving by reusing TR 36.843 and/or TR 38.840 (to be completed by
RAN#89) [RAN1]

| | |
|---|---|
| • | Note: TR 37.885 is reused for the other evaluation assumption and |
| | performance metric. Vehicle dropping model B and antenna option 2 shall be |
| | a more realistic baseline for highway and urban grid scenarios. |

2. Resource allocation enhancement:

| | |
|---|---|
| • | Specify resource allocation to reduce power consumption of the UEs [RAN1, |
| | RAN2] |
| • | Baseline is to introduce the principle of Rel-14 LTE sidelink random resource |
| | selection and partial sensing to Rel-16 NR sidelink resource allocation mode 2. |
| • | Note: Taking Rel-14 as the baseline does not preclude introducing a new solution |
| | to reduce power consumption for the cases where the baseline cannot work |
| | properly. |
| • | Study the feasibility and benefit of the enhancement(s) in mode 2 for enhanced |
| | reliability and reduced latency in consideration of both PRR and PIR defined in |
| | TR37.885 (by RAN#91), and specify the identified solution if deemed feasible |
| | and beneficial [RAN1, RAN2] |
| • | Inter-UE coordination with the following until RAN#90. |
| • | A set of resources is determined at UE-A. This set is sent to UE-B in mode 2, |
| | and UE-B takes this into account in the resource selection for its own |
| | transmission. |
| • | Note: The study scope after RAN#90 is to be decided in RAN#90. |
| • | Note: The solution should be able to operate in-coverage, partial coverage, and |
| | out-of-coverage and to address consecutive packet loss in all coverage scenarios. |
| • | Note: RAN2 work will start after [RAN#89]. |

3. Sidelink DRX for broadcast, groupcast, and unicast [RAN2]

| | |
|---|---|
| • | Define on- and off-durations in sidelink and specify the corresponding UE procedure |
| • | Specify mechanism aiming to align sidelink DRX wake-up time among the UEs |
| | communicating with each other |
| • | Specify mechanism aiming to align sidelink DRX wake-up time with Uu DRX wake-up |
| | time in an in-coverage UE |

4. Support of new sidelink frequency bands for single-carrier operations [RAN4]

| | |
|---|---|
| • | Support of new sidelink frequency bands should ensure coexistence between sidelink |
| | and Uu interface in the same and adjacent channels in licensed spectrum. |
| • | The exact frequency bands are to be determined based on company input during the WI, |
| | considering both licensed and ITS-dedicated spectrum in both FR1 and FR2. |

5. Define mechanism to ensure sidelink operation can be confined to a predetermined
geographic area(s) for a given frequency range within non-ITS bands [RAN2].

| | |
|---|---|
| • | This applies areas where there is no network coverage. |

6. UE Tx and Rx RF requirement for the new features introduced in this WI [RAN4]
7. UE RRM core requirement for the new features introduced in this WI [RAN4]

The DCR message does not have a specified QoS profile, and when SL-DRX is applied, it is transmitted by applying common (/default) SL-DRX.

A UE currently performing SL communication may report information required for SL communication to the gNB through a SidelinkUEInformation (SUI) message. For example, the UE may report the cast type, destination address, QoS profile information, and so on of the message to be transmitted to the gNB by an SL-TxResourceReqList-r16 component included in the SUI message. Upon receipt of the message, the gNB may configure an appropriate resource pool and resource information required for the UE to transmit the message, based on the received information. Further, in the case of UC, SL-TxResourceReqList-v1700 may be used to indicate whether SL DRX is ON/OFF. When SL DRX is ON, the gNB may perform an operation such as allocating SL resources for an active time, when allocating resources.

There are two methods of determining an (L2) DST (DeSTination) address of a DCR. One is a service-specific determination method in which the DST address is determined according to a service. Since the DST address is determined according to a service, the gNB may also identify whether the message is for DCR, once it knows the DST address.

The other method of determining a DST address in a DCR message is a UE-specific determination method. The higher layer of the UE unilaterally determines the DST address. Even if the gNB receives a report of the DST address, the gNB may not identify whether the corresponding message is for a DCR. In this case, since the gNB may not know whether to apply the default/common SL DRX to the DCR message, it may not allocate resources suitable for an active time of the default/common SL DRX.

Therefore, an embodiment of the present disclosure below proposes a method of indicating to a gNB that a DST address is for transmitting/receiving a DCR message through SL-DRX according to how the DST address is determined as described above.

First, when a new DCR specific component for DCR reporting to the gNB is added to SUI, the gNB may identify that it is a report for a DCR message through the component.

When a DST address is determined service-specifically, the UE transmits a DST (L2) address and a cast type (e.g., Broadcast (BC)) of the DCR to the gNB. In this case, the gNB may infer whether the corresponding DCR message will operate in DRX ON or OFF, simply from the reported DST address. This is based on the assumption that the gNB and the UE have common SL DRX ON/OFF information associated with the DST address. When determining DRX ON based on the DST address, the gNB may assume that the UE transmits the DCR message through a default SL DRX configuration, and allocate/configure resources for it.

Alternatively, in the case where the DST address is determined UE-specifically, when the UE transmits the DST (L2) address and a cast type (e.g. unicast (UC)) for DCR transmission to the gNB, the gNB may identify that the DST address is used for transmitting the DCR message because the DST address is transmitted to the gNB through a DCR-specific component. However, it may not be identified simply from the reported DST address whether the DCR message will be transmitted using SL DRX. Accordingly. In this case, the UE should report whether SL DRX is ON/OFF to the gNB, along with the DST address and the cast type. When SL DRX is reported as ON, the gNB may assume that the DST address is operated based on the default SL DRX, and allocate/configure resources for it.

Regardless of whether the DST address is generated service-specifically or UE-specifically, the format of the report may be configured identically for commonality. In this case, even if the DST address is generated UE-specifically. SL DRX ON/OFF information may also be reported. In this case, the SL DRX ON/OFF reporting information may be set as an optional reporting value.

In another example, when an existing SUI component is used for DCR reporting to the gNB, the gNB should be able to identify the report for the DCR message through the (existing) component. Additional signaling may be required for this.

In the case where the DST address is determined service-specifically, when the UE reports the DST address to the gNB through SL-TxResourceReq-r16 of the SUI, the gNB may identify that the address is for transmitting the DCR message. Therefore, when the UE transmits the DST address and the cast type set to BC for the DCR message (in this case, the QoS profile value of the DCR does not exist, and thus may not be transmitted), the gNB may identify that it is a DCR message (generated service-specifically), using the DST message and the cast type (because of BC transmission). The gNB may infer whether the DCR message is subject to DRX ON or OFF through the DST address. When determining that the DST address is for a DCR to which DRX ON is applied, the gNB may apply the default SL DRX to allocate/configure related resources.

Alternatively, when the DST address is determined UE-specifically, even if the UE reports the DST address through SL-TxResourceReq-r16 of the SUI, the gNB may not identify that the DST address is for transmitting a DCR message. Therefore, the UE should report an indication that the DST address is for a DCR message (or an indication that the default SL DRX should be applied), along with the DST address. Further. (when it is indicated that the DST address is for a DCR message). DRX ON/OFF may also need to be reported because the gNB may not identify whether DRX is ON/OFF.

Even when the DST address is generated service-specifically, the indication indicating whether the DST address is for a DCR message (or indicating that the default SL DRX should be applied) may be reported along with the DST address, as in the case where the DST address is generated UE-specifically, for the sake of reporting consistency.

The above embodiment is a solution applicable and extendable to overcome loss caused by interruption that occurs during Uu bandwidth part (BWP) switching. Further, it is also a solution applicable and extendable to overcome loss caused by interruption that occurs during sidelink BWP switching, when a UE supports sidelink multiple BWPs.

The proposed contents of the present disclosure may be extended to not only a default/common sidelink DRX configuration, a default/common sidelink DRX pattern, or parameters (and timers) included in the default/common sidelink DRX configuration, but also a UE-pair specific sidelink DRX configuration, a UE-pair specific sidelink DRX pattern, or parameters (and timers) included in the UE-pair specific sidelink DRX configuration. In addition, the term as used in the proposal of the present disclosure. Onduration may be extended to be interpreted as an active time period (a period in which the UE operates in a wake up state (RF module is “On”) to receive/transmit a wireless signal). The term. Offduration may be extended to be interpreted as a sleep time period (a period in which the UE operates in a sleep mode state (RF module is “Off”) to save power, and it does not mean that a transmitting UE should operate necessarily in the sleep mode during the sleep time period. When needed, the UE is allowed to operate in the active time for a short time for a sensing operation/transmission operation even during the sleep time). Further, “whether (some of) the proposed methods/rules of the present disclosure are applied and/or related parameters (e.g., thresholds) may be specifically (or differently or independently) configured according to a resource pool, a congestion level, a service priority (and/or type), QoS requirements (e.g., latency or reliability) or PQI, a traffic type (e.g., periodic (aperiodic) generation), a sidelink transmission resource allocation mode (mode 1 or mode 2), and so on.”

For example, whether the proposed rules of the present disclosure are applied (and/or set related parameter values) may be configured specifically (and/or independently and/or differently) for at least one of a resource pool, a service/packet type (and/or priority), QoS requirements (e.g., URLLC/EMBB traffic, reliability, or latency), a PQI, a cast type (e.g., unicast, groupcast, or broadcast), a (resource pool) congestion level (e.g., CBR), an SL HARQ feedback scheme (e.g., NACK only feedback or ACK/NACK feedback), a case of HARQ feedback enabled MAC PDU (and/or HARQ feedback disabled MAC PDU) transmission, whether to configure a PUCCH-based SL HARQ feedback reporting operation, a case of performing pre-emption (and/or re-evaluation) (or resource reselection based on it), an (L2 or L1) (source and/or destination) ID, an (L2 or L1) ID (for a combination of source layer ID and destination layer ID), an (L2 or L1) ID (for a combination of a pair of source layer ID and destination layer ID and a cast type), a PC5 RRC connection/link, a case of performing SL DRX, an SL mode type (resource allocation mode 1 or resource allocation mode 2), or periodic (aperiodic) resource reservation.

The term “certain time” mentioned in the proposal of the present disclosure refers to a predefined time as an active time during which a UE operates to receive a sidelink signal or sidelink data from a peer UE or refers to the time of a specific timer (sidelink DRX retransmission timer, sidelink DRX inactivity Timer, or a timer ensuring a time as an active time during which the RX UE may operate in a DRX operation) as an active time.

In addition, whether to apply the proposal and rules of the present disclosure (and/or set related parameter values) may also be applied to an mmWave sidelink operation.

Examples of communication systems applicable to the present disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

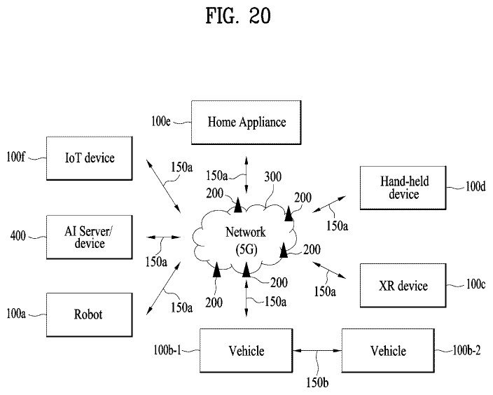

FIG. 20 illustrates a communication system 1 applied to the present disclosure.

Referring to FIG. 20, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a. 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices Applicable to the Present Disclosure

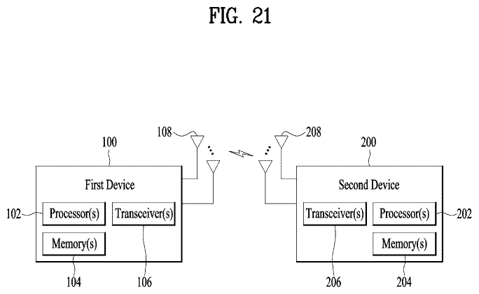

FIG. 21 illustrates wireless devices applicable to the present disclosure.

Referring to FIG. 21, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 20.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC. PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods,
and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of a vehicle or an autonomous driving vehicle applicable to the present disclosure

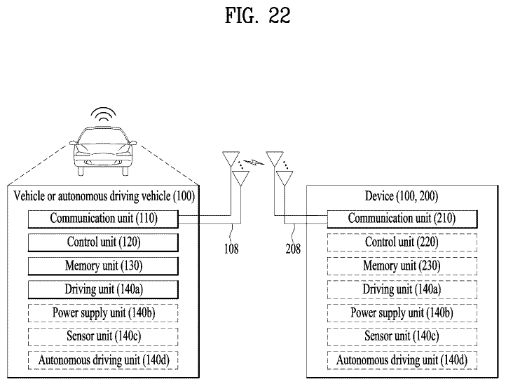

FIG. 22 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 22, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

### Examples of a Vehicle and AR/VR Applicable to the Present Disclosure

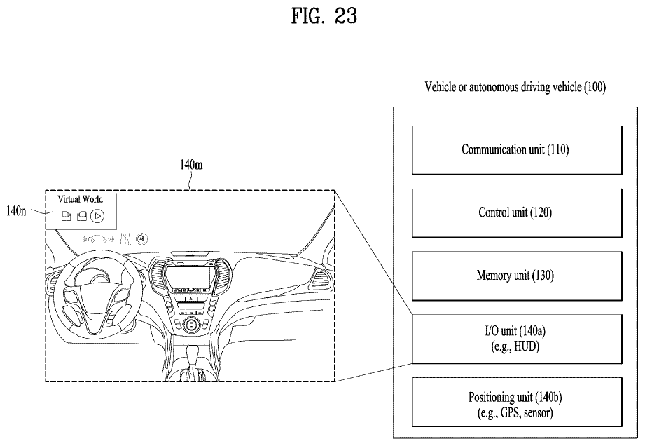

FIG. 23 illustrates a vehicle applied to the present disclosure. The vehicle may be implemented as a transport means, an aerial vehicle, a ship, etc.

Referring to FIG. 23, a vehicle 100 may include a communication unit 110, a control unit 120, a memory unit 130, an I/O unit 140a, and a positioning unit 140b.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410) and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

### Examples of an XR Device Applicable to the Present Disclosure

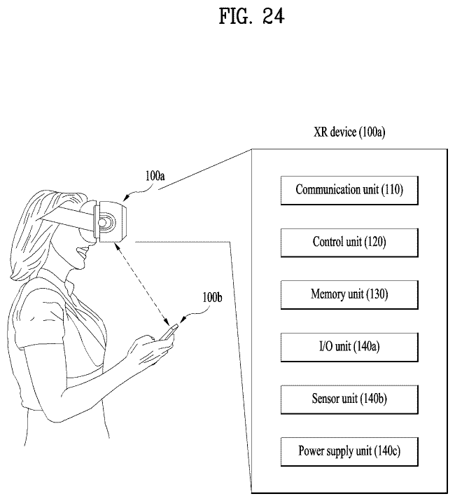

FIG. 24 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 24, an XR device 100a may include a communication unit 110, a control unit 120, a memory unit 130, an I/O unit 140a, a sensor unit 140b, and a power supply unit 140c.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

### Examples of a Robot Applicable to the Present Disclosure

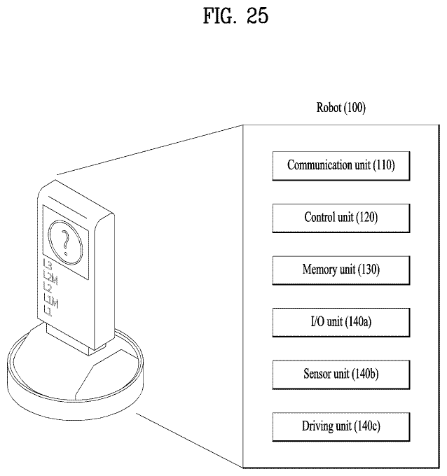

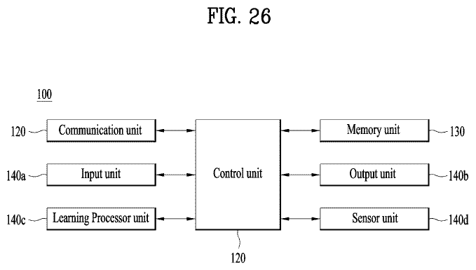

FIG. 25 illustrates a robot applied to the present disclosure. The robot may be categorized into an industrial robot, a medical robot, a household robot, a military robot, etc., according to a used purpose or field.

Referring to FIG. 25, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 21, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

Example of AI Device to which the Present Disclosure is Applied.

FIG. 24 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 24, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 21, respectively.

The communication unit 110 may transmit and receive wired/radio signals (e.g., sensor information, user input, learning models, or control signals) to and from external devices such as other AI devices (e.g., 100x, 200, or 400 of FIG. 20) or an AI server (e.g., 400 of FIG. 20) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 20). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 20). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

The above-described embodiments of the present disclosure are applicable to various mobile communication systems.

What is claimed is:

1. A method of operating a remote user equipment (UE) related to multi-path relay in a wireless communication system, the method comprising:
establishing a radio resource control (RRC) connection with a base station (BS) by the remote UE;
identifying that the remote UE has an ideal link connection to a relay UE by the remote UE; and
reporting to the BS that the remote UE has the ideal link connection by the remote UE,
wherein based on having the ideal link connection, the remote UE ignores a configuration related to a multi-path relay operation, received from the BS.

2. The method according to claim 1, wherein the ideal link connection corresponds to a non-3GPP radio access technology (RAT).

3. The method according to claim 2, wherein the non-3GPP RAT includes Bluetooth and Wi-Fi.

4. The method according to claim 1, wherein the configuration related to the multi-path relay operation includes at least one of
1) a QoS split configuration,
2) an SL bearer configuration related to relay,
3) an SL pool configuration,
4) related grant information in case of operation in Model,
5) a measurement report for a candidate relay UE, or
6) a bearer mapping-related configuration.

5. The method according to claim 1, wherein even if the remote UE has the ideal link connection, the BS configures at least one of a Uu data bearer required to forward data of the remote UE to the relay UE, a local ID to be used for transmitting data of the remote UE between the relay UE and the BS, information related to a HO command, or information related to a HO failure.

6. The method according to claim 1, wherein the HO command and the HO failure are related to HO of the remote UE and the relay UE to the same BS.

7. The method according to claim 1, wherein the report includes a source ID (SRC ID) and a destination ID (DST ID) assigned by a higher layer.

8. The method according to claim 1, wherein the report includes a link ID of an ideal link.

9. The method according to claim 1, wherein the report is performed through SidelinkUEInformation (SUI).

10. The method according to claim 1, wherein the report is performed through a higher layer of the remote UE.

11. A remote user equipment (UE) in a wireless communication system, comprising:
at least one processor; and
at least one computer memory operatively connected to the at least one processor, and storing instructions that, when executed, cause the at least one processor to perform operations,
wherein the operations include:
establishing a radio resource control (RRC) connection with a base station (BS) by the remote UE;
identifying that the remote UE has an ideal link connection to a relay UE by the remote UE; and
reporting to the BS that the remote UE has the ideal link connection by the remote UE, and
wherein based on having the ideal link connection, the remote UE ignores a configuration related to a multi-path relay operation, received from the BS.

12. The remote UE according to claim 11, wherein the remote UE communicates with at least one of another UE, a UE related to an autonomous driving vehicle, a BS, or a network.
